(19) United States
(12) Patent Application Publication
(10) Pub. No.: US 2026/0309240 A1
(43) Pub. Date: Oct. 8, 2026

(54) MULTI-WAY SWITCHING VALVE DEVICE

(71) Applicant: MIKUNI CORPORATION, Tokyo (JP)

(72) Inventors: Shoichi ISHIGUCHI, Kanagawa (JP); Kazufumi YOSHIYA, Kanagawa (JP); Yuichi KOIKE, Kanagawa (JP); Tomonori KAKIZOE, Kanagawa (JP)

(73) Assignee: MIKUNI CORPORATION, Tokyo (JP)

(21) Appl. No.: 19/437,350

(22) Filed: Dec. 31, 2025

(30) Foreign Application Priority Data
Apr. 3, 2025 (JP) 2025-061916

(51) Int. Cl. F16K 11/076; F16K 27/00; F16K 31/04

(52) U.S. Cl. CPC F16K 11/076; F16K 27/00; F16K 31/041

(57) ABSTRACT

A multi-way switching valve device includes: a base member having a cylindrical recess centered on a predetermined axis and a plurality of openings formed on an inner circumferential surface of the cylindrical recess within an angle range narrower than a half circumference to define an inlet and an outlet of each of a plurality of fluid passages; a columnar multi-way switching valve having a plurality of hollowed-out passage parts on an outer circumferential surface and rotatably disposed around the axis in the cylindrical recess to perform opening and closing operations of the plurality of openings; a seal member disposed between the inner circumferential surface and the outer circumferential surface corresponding to the angle range; and a spacer member disposed between the inner circumferential surface and the outer circumferential surface in a region on an opposite side of the seal member across the axis.

### CROSS-REFERENCE TO RELATED APPLICATION

This application claims the priority benefits of Japanese application no. 2025-061916, filed on Apr . 3, 2025. The entirety of the above-mentioned patent application is hereby incorporated by reference herein and made a part of this specification.

### BACKGROUND

### Technical Field

The disclosure relates to a multi-way switching valve device that switches fluid flow in a plurality of directions, and particularly relates to a multi-way switching valve device that adjusts the flow of heat medium (cooling water) in a temperature control system including an HVAC system (for heating, ventilation, air conditioning, etc. of a cabin) mounted on an electric vehicle or the like.

### Related Art

As a conventional multi-way switching valve device, an integrated multi-directional solenoid valve is known that includes a mounting panel in which a plurality of passage ports are opened, a cylindrical valve seat that is fixedly connected to the mounting panel and in which a plurality of openings corresponding to the plurality of passage ports are opened, a columnar spool that is provided within the valve seat so as to be in close contact with the valve seat and in which a plurality of communication grooves are provided, and a drive assembly that rotationally drives the spool (for example, see Patent Document 1).

In this integrated multi-directional solenoid valve, the cylindrical valve seat is connected to a rectangular flat plate-shaped mounting panel, which results in a structure that occupies a large area, increases the number of components, and complicates assembly man-hours.

Moreover, as another multi-way switching valve device, an integrated coolant bottle assembly is known that is used in a reservoir within a thermal system and includes a reservoir section, a multi-valve mounting interface, an integrated channel, and a plurality of hose interfaces, with a multi-valve disposed within the multi-valve mounting interface (for example, see Patent Document 2).

In this integrated coolant bottle assembly, it is necessary to assemble various components from the lower side in the vertical direction and from the lateral direction with respect to the reservoir section disposed on the upper side in the vertical direction, making it difficult to unify the assembly direction, which may cause increased setup man-hours and complications in assembly work.

Furthermore, as another multi-way switching valve device, a fluid control assembly is known that includes a connector including a side wall part that forms part of an accommodation chamber, a valve body, a sealing member, and a drive assembly (for example, see Patent Document 3).

In this fluid control assembly, a flow path plate and drive assembly are attached from one side to the connector, and a valve body, sealing member, bottom cover, etc. are attached from the other side. Therefore, it is difficult to unify the assembly direction, which may cause increased setup man-hours and complications in assembly work.

### Citation List

### Patent Document

Patent Document 1 Japanese Patent Application Laid-Open Publication No. 2023-552502

Patent Document 2Japanese Patent No. 6914972

Patent Document 3 Japanese Patent Application Laid-Open Publication No. 2024-530313

The disclosure has been made in view of the above circumstances, and its object is to provide a multi-way switching valve device capable of achieving reduction and simplification of man-hours in assembly work, reduction in the number of components, weight reduction, miniaturization and space saving through integrated arrangement of components, reduction of friction resistance during driving, and the like.

### SUMMARY

A multi-way switching valve device of the disclosure includes a base member having a cylindrical recess centered on a predetermined axis and a plurality of openings formed on an inner circumferential surface of the cylindrical recess within an angle range narrower than a half circumference to define an inlet and an outlet of each of a plurality of fluid passages; a columnar multi-way switching valve having a plurality of hollowed-out passage parts on an outer circumferential surface and rotatably disposed around the axis in the cylindrical recess to perform opening and closing operations of the plurality of openings; a seal member disposed between the inner circumferential surface and the outer circumferential surface corresponding to the angle range; and a spacer member disposed between the inner circumferential surface and the outer circumferential surface in a region on an opposite side of the seal member across the axis.

### BRIEF DESCRIPTION OF THE DRAWINGS

FIG. 1 is a system diagram showing a temperature control system including a multi-way switching valve device according to one embodiment of the disclosure.

FIG. 2 is an external perspective view of the multi-way switching valve device according to one embodiment as viewed from an upper diagonal direction in one direction.

FIG. 3 is an external perspective view of the multi-way switching valve device according to one embodiment as viewed from an upper diagonal direction in another direction.

FIG. 4 is an external perspective view of the multi-way switching valve device according to one embodiment as viewed from a lower diagonal direction.

FIG. 5 is an exploded perspective view of the multi-way switching valve device according to one embodiment.

FIG. 6 is a perspective view showing a base member forming a part of the multi-way switching valve device according to one embodiment.

FIG. 7 is a perspective cross-sectional view of a base member forming a part of the multi-way switching valve device according to one embodiment, cut along a plane passing through an axis of a cylindrical recess.

FIG. 8 is a partial plan view of a region of a cylindrical recess of a base member forming a part of the multi-way switching valve device according to one embodiment, as viewed from a direction of an axis.

FIG. 9 is a perspective cross-sectional view of a base member forming a part of the multi-way switching valve device according to one embodiment, cut along a plane perpendicular to an axis.

FIG. 10 is a perspective cross-sectional view of a base member forming a part of the multi-way switching valve device according to one embodiment, cut along a plane perpendicular to an axis.

FIG. 11 is an external perspective view of a multi-way switching valve forming a part of the multi-way switching valve device according to one embodiment, as viewed from an upper diagonal direction.

FIG. 12 is an external perspective view of a multi-way switching valve forming a part of the multi-way switching valve device according to one embodiment, as viewed from a lower diagonal direction.

FIG. 13 is a plan view of a multi-way switching valve forming a part of the multi-way switching valve device according to one embodiment, as viewed from above.

FIG. 14 is a cross-sectional view of a multi-way switching valve forming a part of the multi-way switching valve device according to one embodiment, cut along a plane perpendicular to an axis in a region of a first outer circumferential surface (upper stage).

FIG. 15 is a cross-sectional view of a multi-way switching valve forming a part of the multi-way switching valve device according to one embodiment, cut along a plane perpendicular to an axis in a region of a second outer circumferential surface (lower stage).

FIG. 16 is a cross-sectional view of a multi-way switching valve forming a part of the multi-way switching valve device according to one embodiment, cut along a plane perpendicular to an axis in an intermediate region between a first outer circumferential surface (upper stage) and a second outer circumferential surface (lower stage).

FIG. 17 is a perspective cross-sectional view of a multi-way switching valve forming a part of the multi-way switching valve device according to one embodiment, cut along a plane perpendicular to an axis in a region of a first outer circumferential surface (upper stage).

FIG. 18 is a perspective view showing a seal member and a spacer member forming a part of the multi-way switching valve device according to one embodiment.

FIG. 19 is a partial cross-sectional view of a region of the multi-way switching valve and drive unit of the multi-way switching valve device according to one embodiment, cut along a plane including the axis.

FIG. 20 is a perspective view showing an interior of a drive unit forming a part of the multi-way switching valve device according to one embodiment.

FIG. 21 is a schematic diagram schematically showing a first refrigerant-heat medium heat exchanger and a second refrigerant-heat medium heat exchanger forming a part of the multi-way switching valve device according to one embodiment.

FIG. 22 is a system diagram showing a flow of fluid (heat medium, refrigerant) in the multi-way switching valve device according to one embodiment in the case of the multi-way switching valve being positioned at a first switching position.

FIG. 23 shows a state of the multi-way switching valve in the multi-way switching valve device according to one embodiment in the case of the multi-way switching valve being positioned at a first switching position, and is a partial cross-sectional view of regions of a first outer circumferential surface (upper stage) and a second outer circumferential surface (lower stage).

FIG. 24 is a system diagram showing a flow of fluid (heat medium) in the multi-way switching valve device according to one embodiment in the case of the multi-way switching valve being positioned at a second switching position.

FIG. 25 shows a state of the multi-way switching valve in the multi-way switching valve device according to one embodiment in the case of the multi-way switching valve being positioned at a second switching position, and is a partial cross-sectional view of regions of a first outer circumferential surface (upper stage) and a second outer circumferential surface (lower stage).

FIG. 26 is a system diagram showing a flow of fluid (heat medium) in the multi-way switching valve device according to one embodiment in the case of the multi-way switching valve being positioned at a third switching position.

FIG. 27 shows a state of the multi-way switching valve in the multi-way switching valve device according to one embodiment in the case of the multi-way switching valve being positioned at a third switching position, and is a partial cross-sectional view of regions of a first outer circumferential surface (upper stage) and a second outer circumferential surface (lower stage).

FIG. 28 is a system diagram showing a flow of fluid (heat medium) in the multi-way switching valve device according to one embodiment in the case of the multi-way switching valve being positioned at a fourth switching position.

FIG. 29 shows a state of the multi-way switching valve in the multi-way switching valve device according to one embodiment in the case of the multi-way switching valve being positioned at a fourth switching position, and is a partial cross-sectional view of regions of a first outer circumferential surface (upper stage) and a second outer circumferential surface (lower stage).

FIG. 30 is a system diagram showing a flow of fluid (heat medium, refrigerant) in the multi-way switching valve device according to one embodiment in the case of the multi-way switching valve being positioned at a fifth switching position (mixing switching position for mixing fluids (heat medium) having different state quantities).

FIG. 31 shows a state of the multi-way switching valve in the multi-way switching valve device according to one embodiment in the case of the multi-way switching valve being positioned at a fifth switching position, and is a partial cross-sectional view of regions of a first outer circumferential surface (upper stage) and a second outer circumferential surface (lower stage).

FIG. 32 shows a relationship between a contact part of the multi-way switching valve and a stopper of a base member, and is a partial cross-sectional view cut along a plane perpendicular to an axis.

FIG. 33 is a table showing fifteen operation modes: operation mode 1 to operation mode 15 at five switching positions in a temperature control system including the multi-way switching valve device according to one embodiment.

### DESCRIPTION OF THE EMBODIMENTS

A multi-way switching valve device of the disclosure includes a base member having a cylindrical recess centered on a predetermined axis and a plurality of openings formed on an inner circumferential surface of the cylindrical recess within an angle range narrower than a half circumference to define an inlet and an outlet of each of a plurality of fluid passages; a columnar multi-way switching valve having a plurality of hollowed-out passage parts on an outer circumferential surface and rotatably disposed around the axis in the cylindrical recess to perform opening and closing operations of the plurality of openings; a seal member disposed between the inner circumferential surface and the outer circumferential surface corresponding to the angle range; and a spacer member disposed between the inner circumferential surface and the outer circumferential surface in a region on an opposite side of the seal member across the axis.

In the multi-way switching valve device described above, each of the seal member and the spacer member may adopt a configuration in which a side contacting the inner circumferential surface is formed of rubber material, and a side contacting the outer circumferential surface is formed of crystalline resin material, for example, fluorine resin such as polytetrafluoroethylene (PTFE).

In the multi-way switching valve device described above, the base member may adopt a configuration in which, as the plurality of fluid passages, it includes a first inlet side passage and a first outlet side passage of a first fluid passage, a second inlet side passage and a second outlet side passage of a second fluid passage, a third inlet side passage and a third outlet side passage of a third fluid passage, and a fourth inlet side passage and a fourth outlet side passage of a fourth fluid passage, and the inlet of each of the first inlet side passage, the second inlet side passage, the third inlet side passage, and the fourth inlet side passage, and the outlet of each of the first outlet side passage, the second outlet side passage, the third outlet side passage, and the fourth outlet side passage are formed on the inner circumferential surface of the cylindrical recess.

In the multi-way switching valve device described above, the multi-way switching valve may adopt a configuration that it includes a rotating shaft centered on the axis, and the base member has a cover member fixed thereto that covers the cylindrical recess while exposing an end part of the rotating shaft, in a state where the multi-way switching valve is inserted into the cylindrical recess along a direction of the axis such that the seal member and the spacer member are interposed between the inner circumferential surface and the outer circumferential surface.

In the multi-way switching valve device described above, a configuration may be adopted that includes a drive unit that applies a driving force to the rotating shaft, and the drive unit is fixed to the base member and/or the cover member along the direction of the axis on an outer side of the cover member.

In the multi-way switching valve device described above, a configuration may be adopted in which the first fluid passage is a first heat medium passage through which a heat medium that performs heat exchange with a storage battery flows, the second fluid passage is a second heat medium passage through which a heat medium that performs heat exchange with a drive motor that drives wheels flows, the third fluid passage is a third heat medium passage through which a heat medium that performs heat exchange with a refrigerant that circulates in a refrigerant passage flows, and the fourth fluid passage is a fourth heat medium passage through which a heat medium that performs heat exchange with outside air via a radiator flows.

In the multi-way switching valve device described above, a configuration may be adopted in which in the base member, a first electric pump that pressure-feeds the heat medium is disposed in the first inlet side passage and a second electric pump that pressure-feeds the heat medium is disposed in the second inlet side passage.

In the multi-way switching valve device described above, a configuration may be adopted in which the first inlet side passage has a first pump accommodation recess that is formed in the middle thereof and opens in a same direction as the cylindrical recess, the first electric pump is accommodated in the first pump accommodation recess along the direction of the axis and fixed to the base member, the second inlet side passage has a second pump accommodation recess that is formed in the middle thereof and opens in the same direction as the cylindrical recess, and the second electric pump is accommodated in the second pump accommodation recess along the direction of the axis and fixed to the base member.

In the multi-way switching valve device described above, a configuration may be adopted in which in the base member, a reservoir tank through which the heat medium passes is disposed in the second outlet side passage.

In the multi-way switching valve device described above, a configuration may be adopted in which the second outlet side passage has a branch port in the middle thereof that opens in a same direction as the cylindrical recess, and the reservoir tank is fixed to the base member so as to communicate with the branch port along the direction of the axis.

In the multi-way switching valve device described above, a configuration may be adopted in which in the base member, a first refrigerant-heat medium heat exchanger that performs heat exchange between the refrigerant and the heat medium is disposed on a downstream side of a reservoir tank in the second outlet side passage.

In the multi-way switching valve device described above, a configuration may be adopted in which the first refrigerant-heat medium heat exchanger includes a heat exchange part, an intermediate passage that forms part of the second heat medium passage, and a first refrigerant passage that forms part of the refrigerant passage, and an on-off valve is disposed on an upstream side of the first refrigerant passage.

In the multi-way switching valve device described above, a configuration may be adopted in which the second outlet side passage has two separation ports separated in the middle thereof and open in a same direction as the cylindrical recess, and the first refrigerant-heat medium heat exchanger is fixed to the base member along the direction of the axis such that the two separation ports communicate with the intermediate passage.

In the multi-way switching valve device described above, a configuration may be adopted in which in the base member, a second refrigerant-heat medium heat exchanger that performs heat exchange between the refrigerant and the heat medium is disposed between the third inlet side passage and the third outlet side passage.

In the multi-way switching valve device described above, a configuration may be adopted in which the second refrigerant-heat medium heat exchanger includes a heat exchange part, an intermediate passage that connects the third inlet side passage and the third outlet side passage, and a second refrigerant passage that forms part of the refrigerant passage, and an expansion valve is disposed on an upstream side of the second refrigerant passage.

In the multi-way switching valve device described above, a configuration may be adopted in which a third downstream port of the third inlet side passage and a third upstream port of the third outlet side passage open in a same direction as the cylindrical recess, and the second refrigerant-heat medium heat exchanger is fixed to the base member along the direction of the axis such that the third downstream port and the third upstream port communicate with the intermediate passage.

According to the multi-way switching valve device having the above configuration, it is possible to achieve reduction and simplification of man-hours in assembly work, reduction of the number of components, weight reduction, miniaturization and space saving by integrated arrangement of components, reduction of friction resistance during driving, and the like.

Hereinafter, embodiments of the disclosure will be described with reference to the accompanying drawings.

The multi-way switching valve device according to the disclosure is applied, for example, in an electric vehicle, in a temperature control system that controls the temperature of various functional components to a desired temperature by performing heat exchange between cooling water (for example, LLC) as a heat medium for various functional components (storage battery, drive motor, etc.) and refrigerant (for example, fluorocarbon gas) and cooling water, in addition to an EV air conditioning (HVAC) system that performs heating, ventilation, air conditioning, etc. of a cabin.

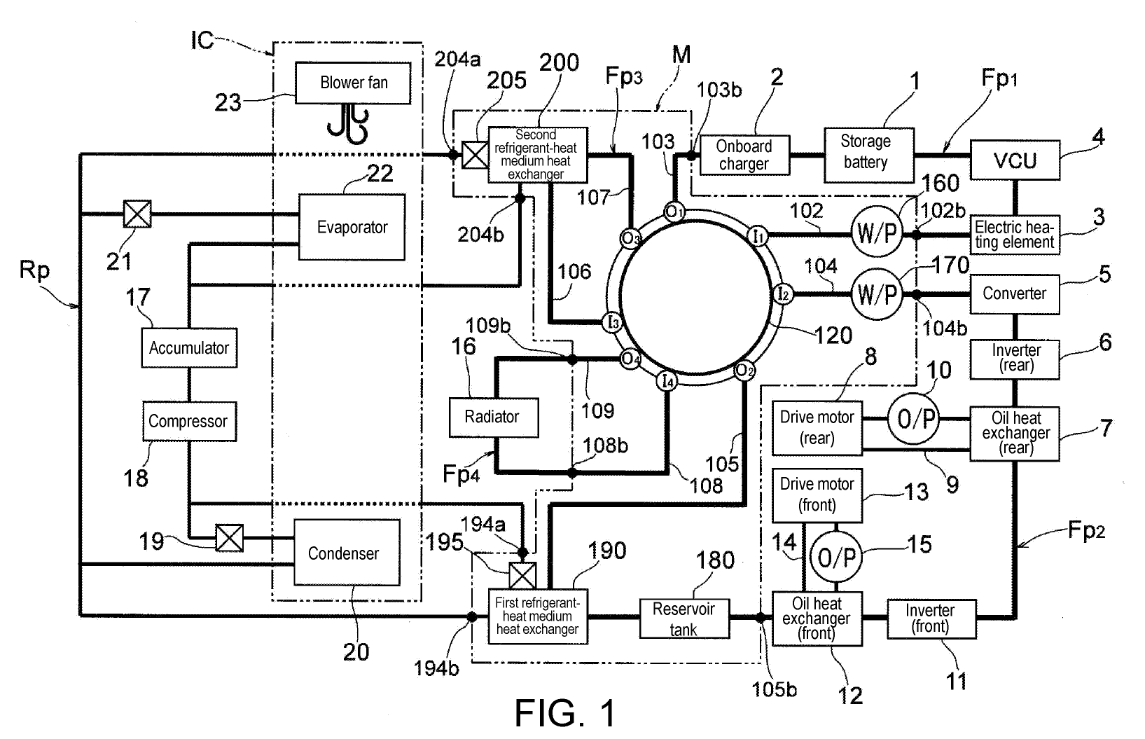

Here, as shown in FIG. 1, the temperature control system includes a first heat medium passage Fp₁ as a first fluid passage, a second heat medium passage Fp₂ as a second fluid passage, a third heat medium passage Fp₃ as a third fluid passage, a fourth heat medium passage Fp₄ as a fourth fluid passage, a refrigerant passage Rp, a storage battery 1, an onboard charger 2, an electric heating element 3, a vehicle control unit 4, a converter 5, an inverter 6, an oil heat exchanger 7, a rear drive motor 8, an oil passage 9, an oil pump 10 as a third electric pump, an inverter 11, an oil heat exchanger 12, a front drive motor 13, an oil passage 14, an oil pump 15 as a third electric pump, a radiator 16, an accumulator 17, a compressor 18, an on-off valve 19, a condenser 20, an expansion valve 21, an evaporator 22, a blower fan 23, a multi-way switching valve device M, and other components.

Here, the condenser 20, the evaporator 22, and the blower fan 23 are disposed in a cabin IC or in a region communicating with the cabin IC.

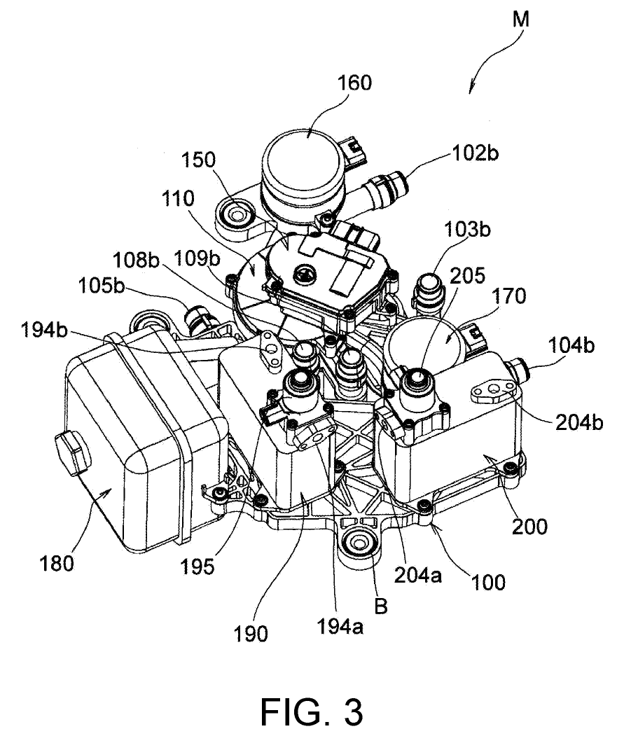

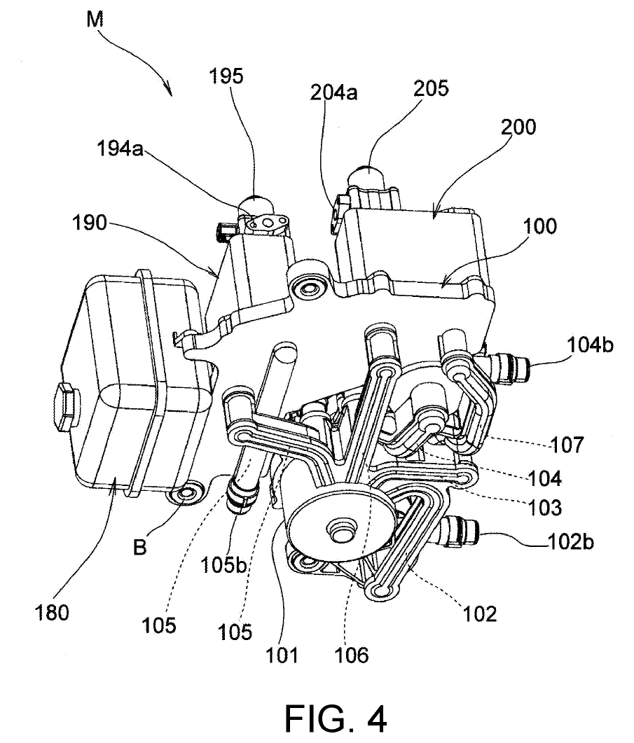

As shown in FIGS. 1-5 , the multi-way switching valve device M according to one embodiment includes a base member 100, a cover member 110, a multi-way switching valve 120, a seal member 130, a spacer member 140, a drive unit 150, a water pump 160 as a first electric pump, a water pump 170 as a second electric pump, a reservoir tank 180, a first refrigerant-heat medium heat exchanger 190, and a second refrigerant-heat medium heat exchanger 200.

The first heat medium passage Fp₁ is disposed such that an inlet I₁ and an outlet O₁ face the multi-way switching valve 120 of the multi-way switching valve device M. In the first heat medium passage Fp₁, the water pump 160, the electric heating element 3, the vehicle control unit 4, the storage battery 1, and the onboard charger 2 are disposed in order from the inlet I₁ toward the outlet O₁.

The storage battery 1 is, for example, a high-voltage battery of 300V to 400V, and is mainly configured as a power source for the rear drive motor 8 and the front drive motor 13, and is disposed at a position facing the first heat medium passage Fp₁ via a heat exchange structure (not shown) so as to enable heat exchange with cooling water flowing through the first heat medium passage Fp₁.

Moreover, as a power source for other electrical components, for example, a low-voltage battery (not shown) of 12V to 48V is provided.

In charging the storage battery 1, the onboard charger 2 serves to convert the voltage of, for example, an EV charging station or household AC power supply to a required voltage, and is disposed at a position facing the first heat medium passage Fp₁ via a heat exchange structure (not shown) so as to enable heat exchange with cooling water flowing through the first heat medium passage Fp₁.

The electric heating element 3 generates heat using the storage battery 1 as a power source, and for example, a PTC (positive temperature coefficient) heater is used, and is disposed at a position facing the first heat medium passage Fp₁ so as to enable heat exchange with cooling water flowing through the first heat medium passage Fp₁. Here, in the case of using a PTC heater as the electric heating element 3, due to its self-regulating characteristics, resistance increases with temperature rise and the flowing current is limited, thereby reducing waste of power consumption.

The vehicle control unit 4 is a control unit that starts up using the low-voltage battery as a power source and controls various functions of the vehicle, and is disposed at a position facing the first heat medium passage Fp₁ via a heat exchange structure (not shown) so as to enable heat exchange with cooling water flowing through the first heat medium passage Fp₁.

The second heat medium passage Fp₂ is disposed such that an inlet I₂ and an outlet O₂ face the multi-way switching valve 120 of the multi-way switching valve device M. In the second heat medium passage Fp₂, a water pump 170, a converter 5, an inverter 6, an oil heat exchanger 7, an inverter 11, an oil heat exchanger 12, a reservoir tank 180, and a first refrigerant-heat medium heat exchanger 190 are disposed in order from the inlet I₂ toward the outlet O₂.

The converter 5 is a DC-DC converter that steps down the voltage of the storage battery 1 to a low voltage (for example, 12 to 48V) suitable for charging the low-voltage battery, and is disposed to face the second heat medium passage Fp₂ via a heat exchange structure (not shown) so as to enable heat exchange with cooling water flowing through the second heat medium passage Fp₂.

The inverter 6 converts direct current to alternating current and steps up to high voltage (for example, 300 to 800V) to make the voltage of the storage battery 1 suitable for driving the rear drive motor 8, and is disposed at a position facing the second heat medium passage Fp₂ via a heat exchange structure (not shown) so as to enable heat exchange with cooling water flowing through the second heat medium passage Fp₂.

The oil heat exchanger 7 serves to transfer heat generated by the rear drive motor 8 to cooling water via oil, and is disposed at a position facing the second heat medium passage Fp₂ so as to enable heat exchange between cooling water flowing through the second heat medium passage Fp₂ and oil.

The rear drive motor 8 drives the rear wheels of the vehicle, and is cooled via oil that undergoes heat exchange with cooling water by circulating oil flowing through the oil passage 9 with the oil pump 10. The oil pump 10 is driven using the low-voltage battery as a power source.

The inverter 11 converts direct current to alternating current and steps up to high voltage (for example, 300 to 800V) to make the voltage of the storage battery 1 suitable for driving the front drive motor 13, and is disposed at a position facing the second heat medium passage Fp₂ via a heat exchange structure (not shown) so as to enable heat exchange with cooling water flowing through the second heat medium passage Fp₂.

The oil heat exchanger 12 serves to transfer heat generated by the front drive motor 13 to cooling water via oil, and is disposed at a position facing the second heat medium passage Fp₂ so as to enable heat exchange between cooling water flowing through the second heat medium passage Fp₂ and oil.

The front drive motor 13 drives the front wheels of the vehicle, and is cooled via oil that undergoes heat exchange with cooling water by circulating oil flowing through the oil passage 14 with the oil pump 15. The oil pump 15 is driven using the low-voltage battery as a power source.

The third heat medium passage Fp₃ is disposed such that an inlet I₃ and an outlet O₃ face the multi-way switching valve 120 of the multi-way switching valve device M. Moreover, the second refrigerant-heat medium heat exchanger 200 is disposed midway in the third heat medium passage Fp₃.

The fourth heat medium passage Fp₄ is disposed such that an inlet I₄and an outlet O₄ face the multi-way switching valve 120 of the multi-way switching valve device M. The radiator 16 is disposed midway in the fourth heat medium passage Fp₄.

The radiator 16 dissipates heat of cooling water flowing through the fourth heat medium passage Fp₄ to outside air.

The refrigerant passage Rp is disposed so as to pass through the first refrigerant-heat medium heat exchanger 190 and the second refrigerant-heat medium heat exchanger 200. The accumulator 17, the compressor 18, the on-off valve 19, the condenser 20, the expansion valve 21, and the evaporator 22 are disposed in the refrigerant passage Rp.

The accumulator 17 is disposed in the refrigerant passage Rp on the downstream side of the evaporator 22 and on the upstream side of the compressor 18, and functions to separate refrigerant into gas and liquid and send only gaseous refrigerant to the compressor 18.

The compressor 18 is driven using the storage battery 1 as a power source, and compresses the refrigerant to a high temperature and pressure and sends it out.

The on-off valve 19 is a solenoid valve driven by a low-voltage battery, and opens and closes the refrigerant passage Rp leading to the condenser 20.

The condenser 20 liquefies the high-temperature and high-pressure gaseous refrigerant sent from the compressor 18, and releases heat to the outside (inside the cabin IC).

The expansion valve 21 is a solenoid valve driven by a low-voltage battery, is disposed in the refrigerant passage Rp on the downstream side of the condenser 20 and the first refrigerant-heat medium heat exchanger 190, and rapidly expands refrigerant to make it low temperature and low pressure.

The evaporator 22 absorbs heat from the outside (inside the cabin IC) through the low-temperature and low-pressure refrigerant that has passed through the expansion valve 21.

The blower fan 23 is driven by a low-voltage battery, and generates forced convection of air to promote heat dissipation action by the condenser 20 and cooling action by the evaporator 22 inside the cabin IC.

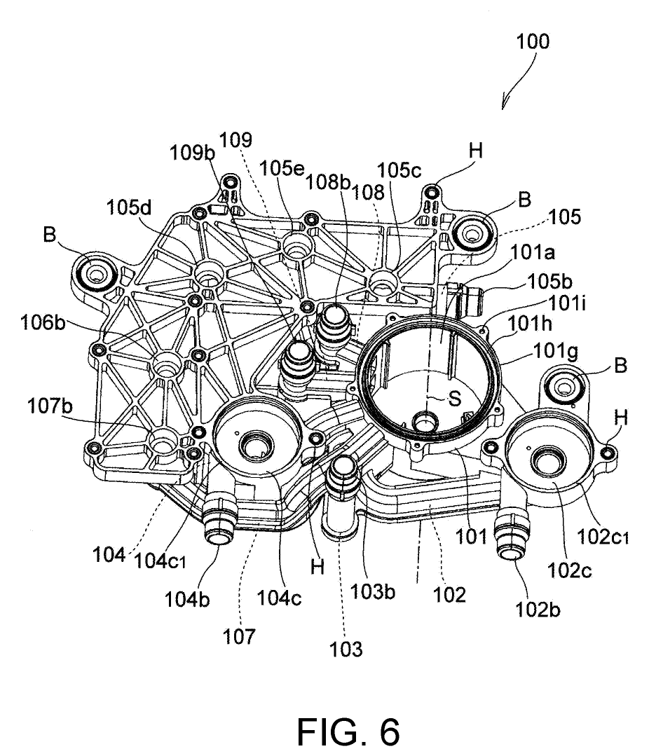

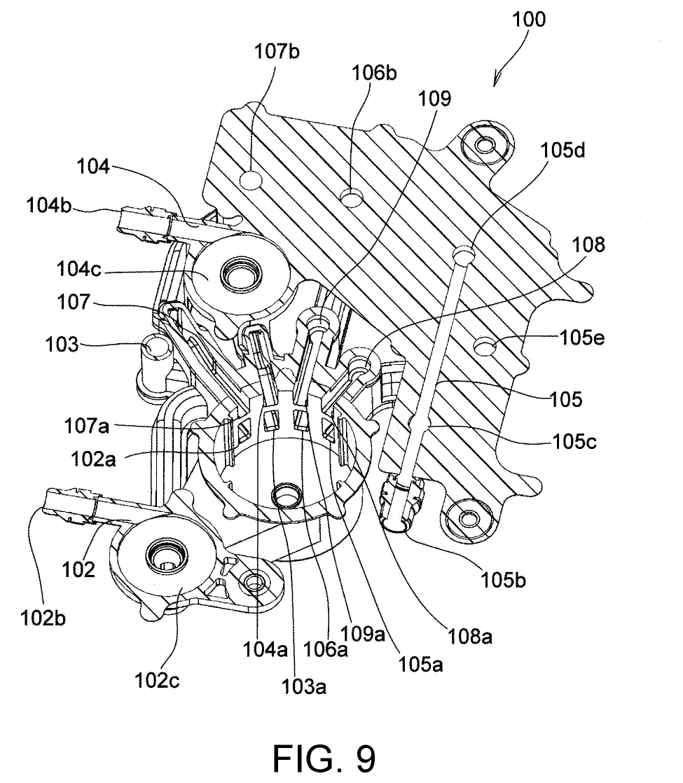

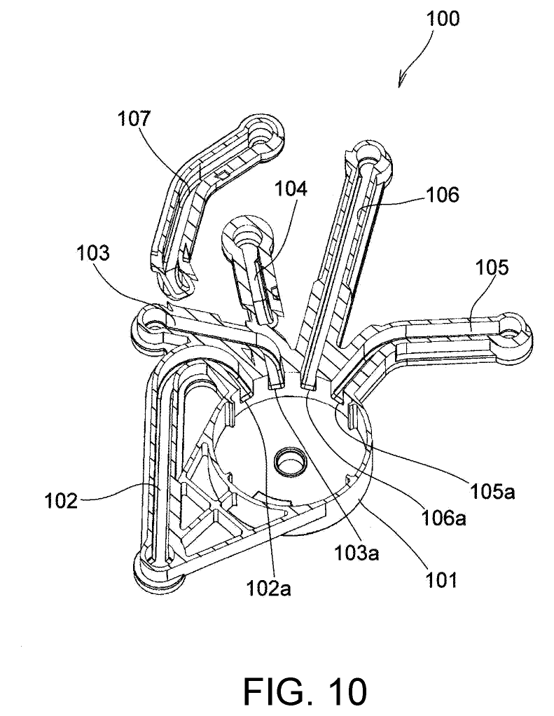

In the multi-way switching valve device M according to one embodiment, the base member 100 is molded using resin material, and as shown in FIGS. 6-10 , includes a cylindrical recess 101 centered on an axis S, a first inlet side passage 102 and a first outlet side passage 103 that form part of the first heat medium passage Fp₁, a second inlet side passage 104 and a second outlet side passage 105 that form part of the second heat medium passage Fp₂, a third inlet side passage 106 and a third outlet side passage 107 that form part of the third heat medium passage Fp₃, a fourth inlet side passage 108 and a fourth outlet side passage 109 that form part of the fourth heat medium passage Fp₄, a plurality of (fourteen) embedded screw holes H, and a plurality of (three) assembled mounting boss parts B.

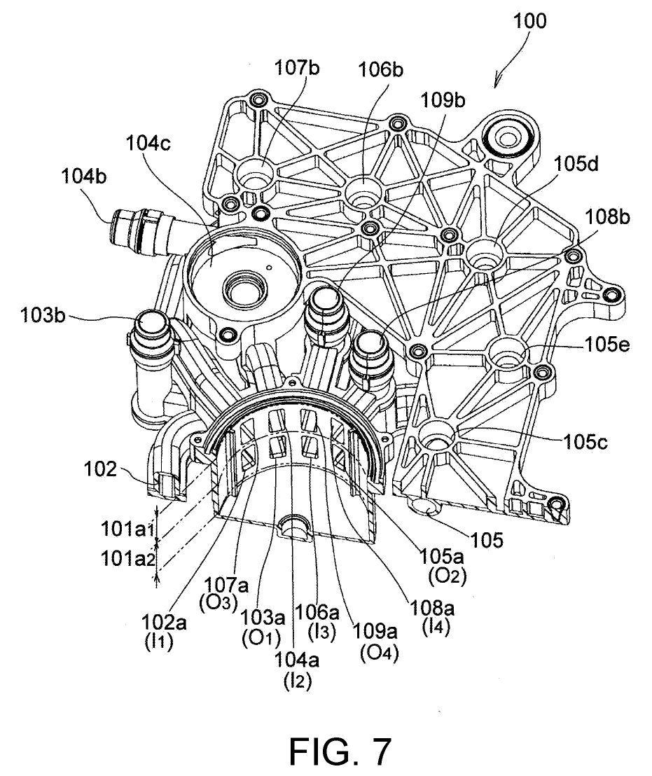

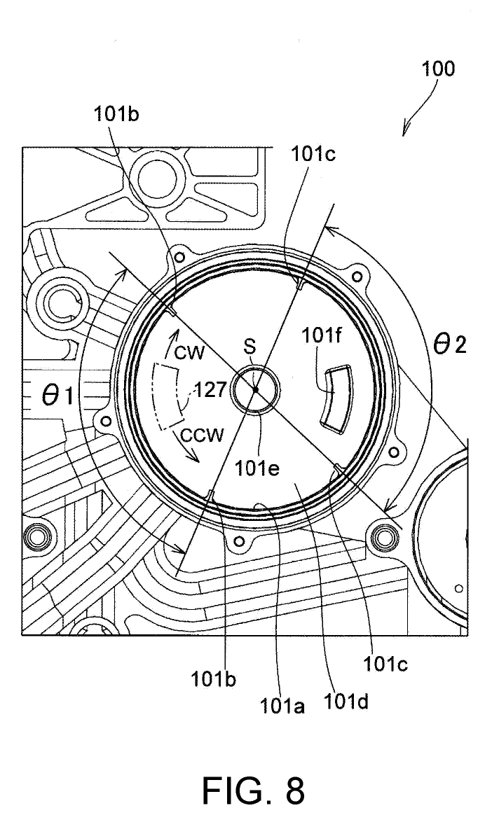

The cylindrical recess 101, as shown in FIGS. 7 and 8 , includes a plurality of openings (inlet I₁, outlet O₁, inlet I₂, outlet O₂, inlet I₃, outlet O₃, inlet I₄, outlet O₄) on an inner circumferential surface 101a centered on the axis S within an angle range θ1 (here, approximately 110 degrees) narrower than a half circumference. Here, the inner circumferential surface 101a includes, as shown in FIG. 7, a first inner circumferential surface 101a₁ and a second inner circumferential surface 101a₂ divided in the axis S direction, with four openings (outlet O₃, inlet I₂, outlet O₄, inlet I₄) disposed in the circumferential direction on the first inner circumferential surface 101a₁, and four openings (inlet I₁, outlet O₁, inlet I₃, outlet O₂) disposed in the circumferential direction on the second inner circumferential surface 101a₂.

Moreover, the inner circumferential surface 101a includes, as shown in FIG. 8, a pair of projection parts 101b for positioning the seal member 130 at a position corresponding to the angle range θ1, and a pair of projection parts 101c for positioning the spacer member 140 in an angle range θ2 (θ1=θ2) located in a region opposite to the angle range θ1 across the axis S.

Furthermore, the cylindrical recess 101 includes, as shown in FIG. 8, a bearing recess 101e for supporting an end part 121a of a rotating shaft 121 of the multi-way switching valve 120 and a stopper 101f for restricting rotation in a bottom wall 101d, and as shown in FIG. 6, includes an annular seal groove 101h for fitting an O-ring Sr₁ and five screw holes 101i in a flange part 101g.

The first inlet side passage 102, as shown in FIGS. 6,7 and 9,7, includes a first inlet 102a through which cooling water flows into the first heat medium passage Fp₁, a first downstream port 102b, and a first pump accommodation recess 102c in the middle.

The first inlet 102a is the inlet I₁ that opens at the second inner circumferential surface 101a₂.

The first downstream port 102b is connected to the first heat medium passage Fp₁on the upstream side of the electric heating element 3.

The first pump accommodation recess 102c is a region that accommodates the water pump 160, and as shown in FIG. 6, is formed parallel to the axis S and open in the same direction as the cylindrical recess 101, and includes a flange part 102c₁ that fixes the water pump 160 at its opening end.

The first outlet side passage 103, as shown in FIGS. 6,7, and 10, includes a first outlet 103a through which cooling water flows out from the first heat medium passage Fp₁ into the cylindrical recess 101, and a first upstream port 103b.

The first outlet 103a is the outlet O₁ that opens at the second inner circumferential surface 101a₂.

The first upstream port 103b is connected to the first heat medium passage Fp₁ on the downstream side of the onboard charger 2.

The second inlet side passage 104, as shown in FIGS. 6,7 and 9, includes a second inlet 104a through which cooling water flows into the second heat medium passage Fp₂, a second downstream port 104b, and a second pump accommodation recess 104c in the middle.

The second inlet 104a is the inlet I₂ that opens at the first inner circumferential surface 101a₁.

The second downstream port 104b is connected to the second heat medium passage Fp₂on the upstream side of the converter 5.

The second pump accommodation recess 104c is a region that accommodates the water pump 170, is formed parallel to the axis S and open in the same direction as the cylindrical recess 101, and includes a flange part 104c₁ that fixes the water pump 170 at its opening end.

The second outlet side passage 105, as shown in FIGS. 6,7 and 9, includes a second outlet 105a through which cooling water flows out from the second heat medium passage Fp₂ into the cylindrical recess 101, a second upstream port 105b, a branch port 105c in the middle parallel to the axis S and open in the same direction as the cylindrical recess 101, and two separation ports 105d, 105e that are separated from the middle on the downstream side of the branch port 105c, parallel to the axis S and open in the same direction as the cylindrical recess 101.

The second outlet 105a is the outlet O₂ that opens at the second inner circumferential surface 101a₂.

The second upstream port 105b is connected to the second heat medium passage Fp₂ on the downstream side of the oil heat exchanger 12.

The reservoir tank 180 is connected to the branch port 105c so as to communicate from the axis S direction.

The first refrigerant-heat medium heat exchanger 190 is connected to the two separation ports 105d, 105e so as to communicate from the axis S direction.

The third inlet side passage 106, as shown in FIGS. 6,7 and 10, includes a third inlet 106a through which cooling water flows into the third heat medium passage Fp₃ and a third downstream port 106b.

The third inlet 106a is the inlet I₃that opens at the second inner circumferential surface 101a₂.

The third downstream port 106b is formed parallel to the axis S and open in the direction as the cylindrical recess 101.

The third outlet side passage 107, as shown in FIGS. 6,7 and 9, includes a third outlet 107a through which cooling water flows out from the third heat medium passage Fp₃into the cylindrical recess 101, and a third upstream port 107b.

The third outlet 107a is the outlet O₃ that opens at the first inner circumferential surface 101a₁.

The third upstream port 107b is formed parallel to the axis S and open in the same direction as the cylindrical recess 101.

Moreover, the third downstream port 106b and the third upstream port 107b are connected to the second refrigerant-heat medium heat exchanger 200 so as to communicate from the axis S direction.

The fourth inlet side passage 108, as shown in FIGS. 6,7 and 9, includes a fourth inlet 108a through which cooling water flows into the fourth heat medium passage Fp₄, and a fourth downstream port 108b.

The fourth inlet 108a is the inlet I₄ that opens at the first inner circumferential surface 101a₁.

The fourth downstream port 108b is formed parallel to the axis S and open in the same direction as the cylindrical recess 101.

The fourth outlet side passage 109, as shown in FIGS. 6,7 and 9, includes a fourth outlet 109a through which cooling water flows out from the fourth heat medium passage Fp₄into the cylindrical recess 101, and a fourth upstream port 109b.

The fourth outlet 109a is the outlet O₄ that opens at the first inner circumferential surface 101a₁.

The fourth upstream port 109b is formed parallel to the axis S and open in the same direction as the cylindrical recess 101.

Moreover, the fourth downstream port 108b and the fourth upstream port 109b are connected to a connection part forming a part of the fourth heat medium passage Fp₄ of the radiator 16 so as to communicate therewith from the axis S direction.

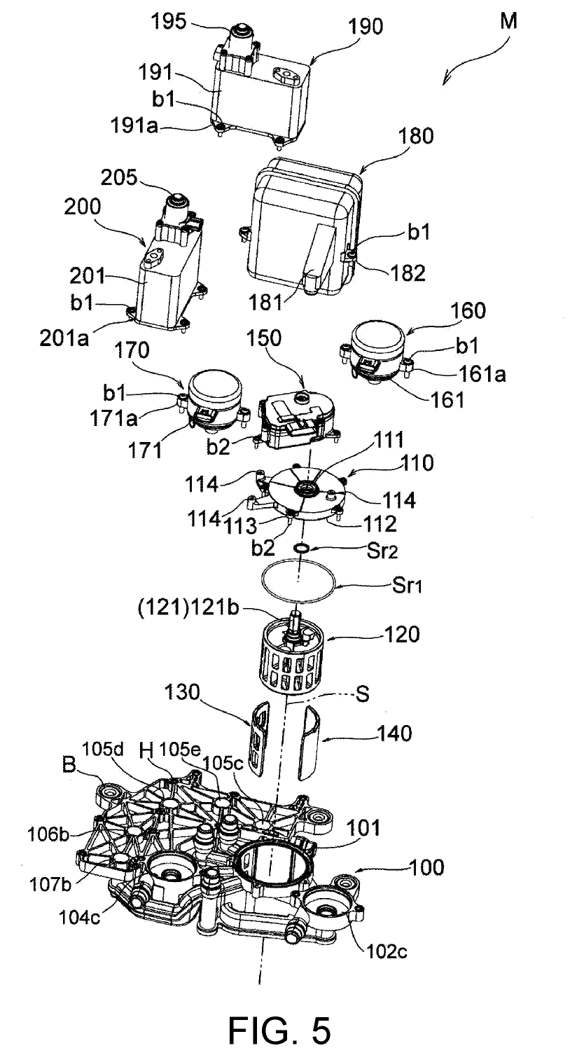

The cover member 110 is formed in a substantially disc shape from resin material, covers the cylindrical recess 101, and serves as a base for fixing the drive unit 150, and as shown in FIG. 5, includes a circular hole 111 through which an end part 121b of the rotating shaft 121 of the multi-way switching valve 120 passes, an annular joint part 112 joined to the flange part 101g of the cylindrical recess 101, five arm parts 113 formed to protrude from the annular joint part 112 and having circular holes through which screws b2 pass, and three boss parts 114 having screw holes into which the screws b2 for fixing the drive unit 150 are screwed.

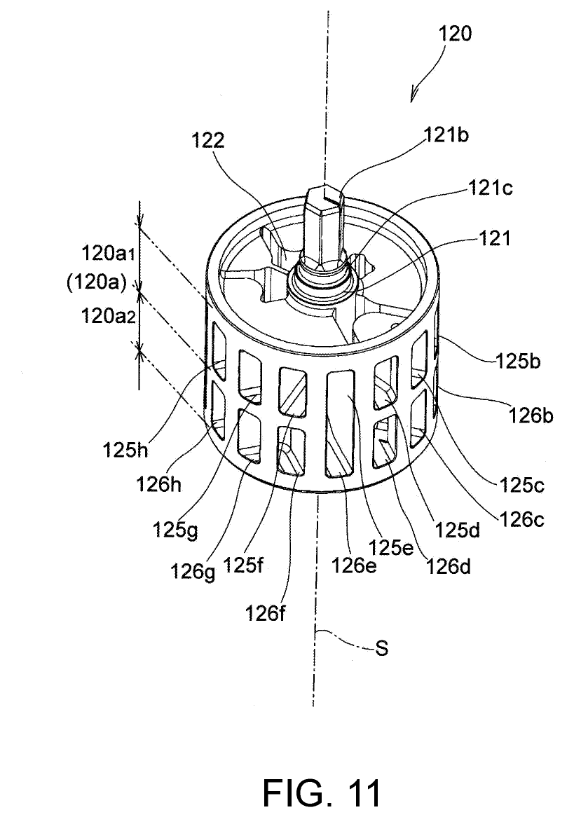

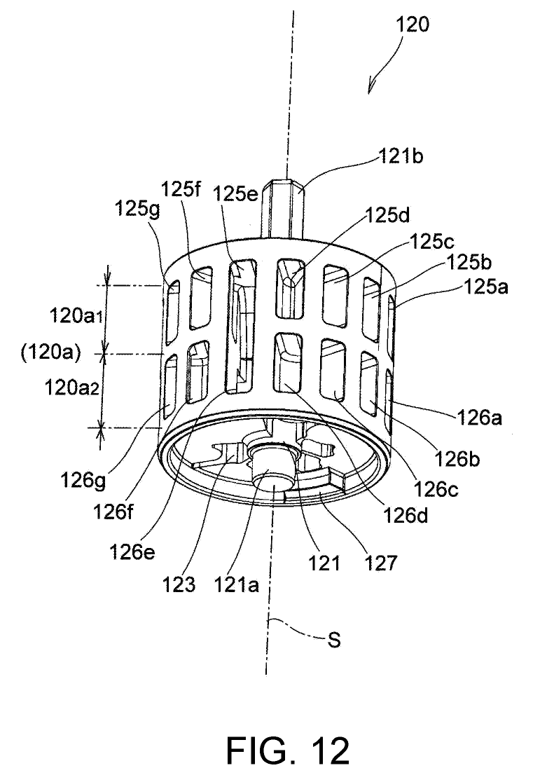

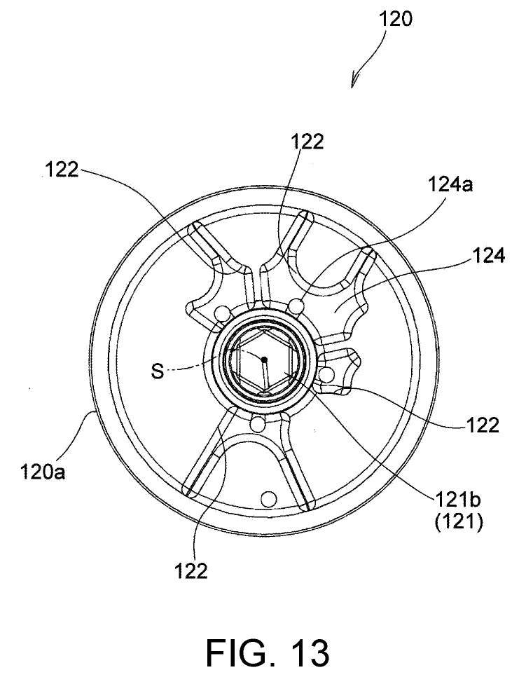

The multi-way switching valve 120 is molded from resin material into a columnar shape centered on the axis S, and as shown in FIGS. 11-17 , includes a rotating shaft 121 centered on the axis S, a first hollowed-out part 122 and a second hollowed-out part 123 that are hollowed out from both sides in the axis S direction around the rotating shaft 121, a partition wall 124 that partitions the first hollowed-out part 122 and the second hollowed-out part 123, fifteen hollowed-out passage parts 125a to 125o on a first outer circumferential surface 120a₁ and fifteen hollowed-out passage parts 126a to 126o on a second outer circumferential surface 120a₂ that are divided in the axis S direction in an outer circumferential surface 120a, and a contact part 127 in the vicinity of the second hollowed-out part 123.

The rotating shaft 121 includes respective end parts 121a, 121b, and an annular seal part 121c formed on the end part 121b side.

The end part 121a is inserted into the bearing recess 101e formed in the bottom wall 101d of the cylindrical recess 101 of the base member 100 and is rotatably supported.

The end part 121b is connected to a gear 155 of the drive unit 150 through the circular hole 111 of the cover member 110.

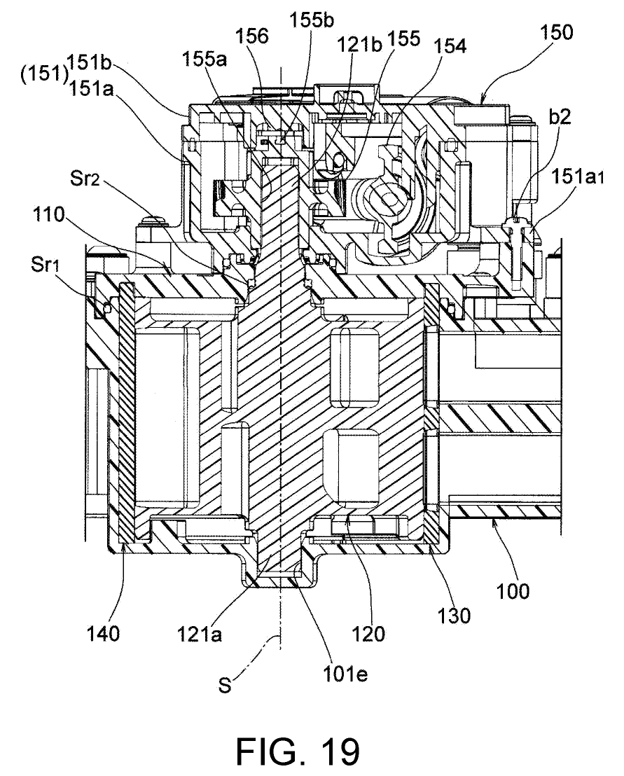

The annular seal part 121c cooperates with the cover member 110 to sandwich an O-ring Sr₂, as shown in FIG. 19.

The partition wall 124 includes a plurality of communication holes 124a that allow communication between the first hollowed-out part 122 and the second hollowed-out part 123.

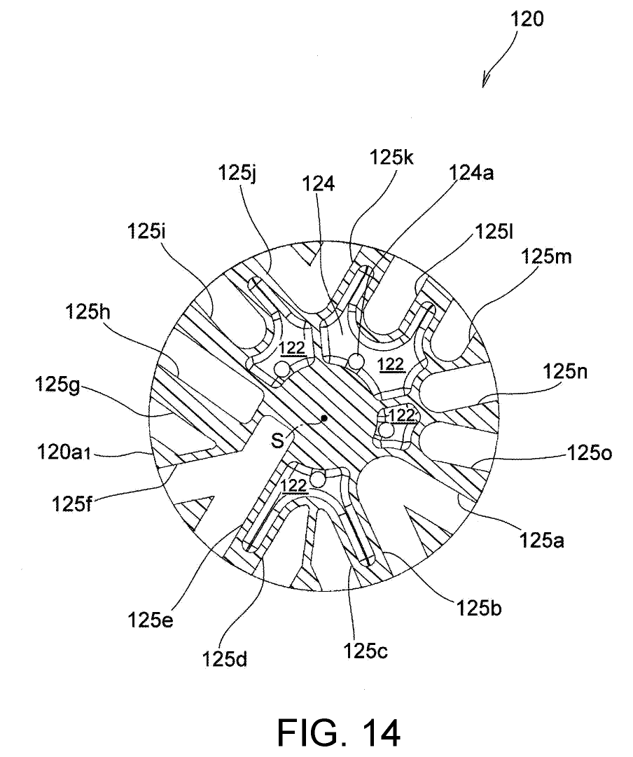

The hollowed-out passage parts 125a to 125o are disposed radially and formed to extend toward the center on the rotating shaft 121 side, as shown in FIG. 14.

Moreover, the hollowed-out passage part 125a and the hollowed-out passage part 125b communicate at the inner side, the hollowed-out passage part 125e and the hollowed-out passage part 125f communicate at the inner side, and the hollowed-out passage part 125j and the hollowed-out passage part 125k communicate at the inner side.

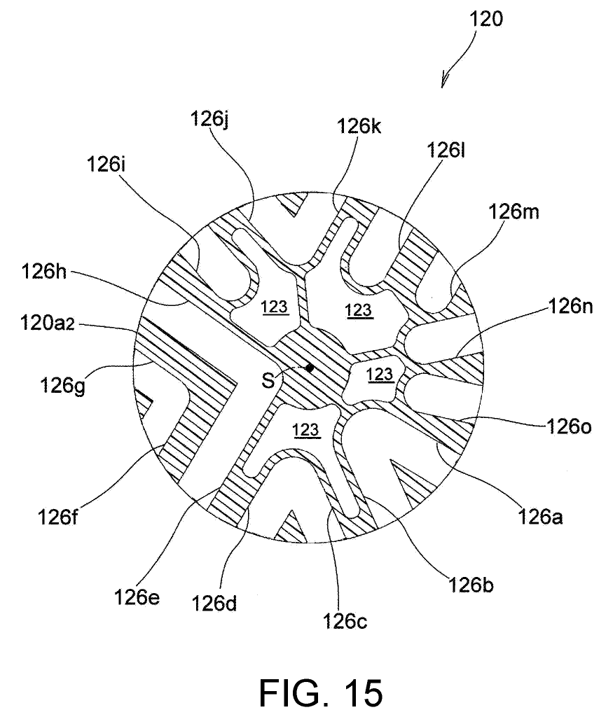

The hollowed-out passage parts 126a to 126o are disposed radially and formed to extend toward the center on the rotating shaft 121 side, as shown in FIG. 15.

Moreover, the hollowed-out passage part 126a and the hollowed-out passage part 126b communicate at the inner side, the hollowed-out passage part 126c and the hollowed-out passage part 126d communicate at the inner side, the hollowed-out passage part 126e and the hollowed-out passage part 126h communicate at the inner side, the hollowed-out passage part 126f and the hollowed-out passage part 126g communicate at the inner side, and the hollowed-out passage part 126j and the hollowed-out passage part 126k communicate at the inner side.

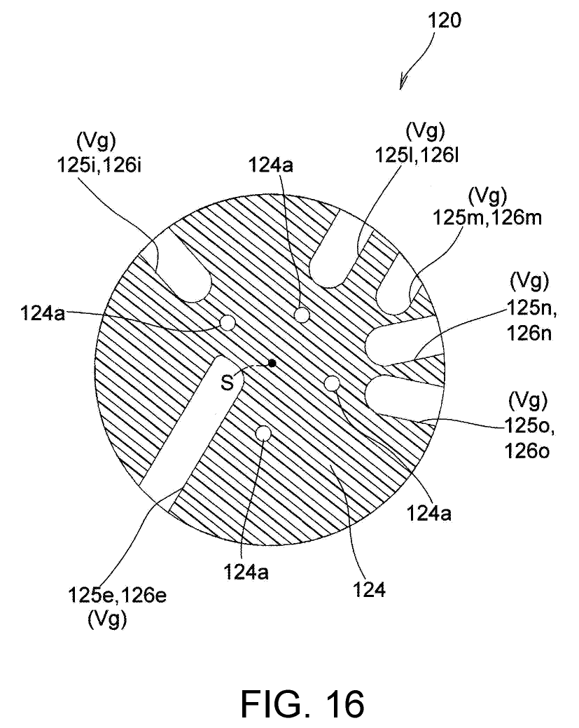

Furthermore, as shown in FIG. 16, the hollowed-out passage part 125e and the hollowed-out passage part 126e, the hollowed-out passage part 125i and the hollowed-out passage part 126i, the hollowed-out passage part 125l and the hollowed-out passage part 126l, the hollowed-out passage part 125m and the hollowed-out passage part 126m, the hollowed-out passage part 125n and the hollowed-out passage part 126n, and the hollowed-out passage part 125o and the hollowed-out passage part 126o are each formed as vertical groove passage parts Vg that communicate with each other in the axis S direction.

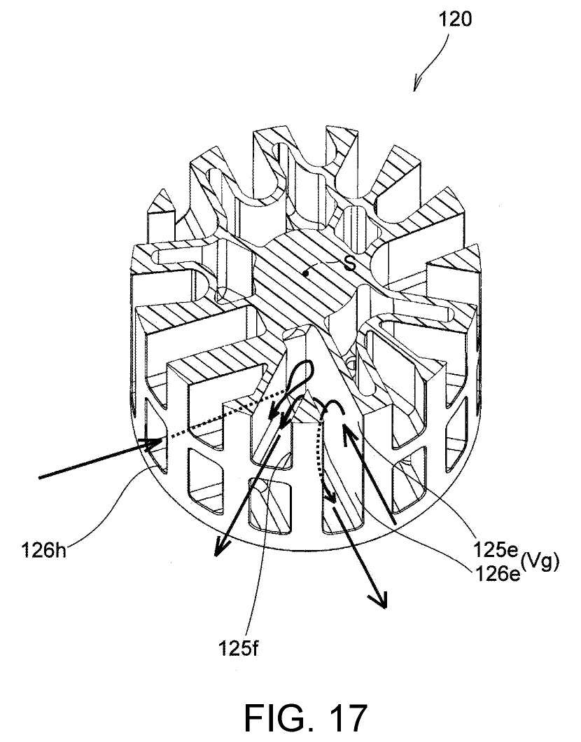

In the above configuration, as shown by the arrows in FIG. 17, the cooling water that flows into the hollowed-out passage part 125e flows out from the hollowed-out passage part 126e and the hollowed-out passage part 125f, and the cooling water that flows in from the hollowed-out passage part 126h flows out from the hollowed-out passage part 125f and the hollowed-out passage part 126e. Therefore, the cooling water that flows in from the hollowed-out passage part 125e and the cooling water that flows in from the hollowed-out passage part 126h mix and flow out from the hollowed-out passage part 126e and flow out from the hollowed-out passage part 125f.

That is, the multi-way switching valve 120 is formed to include the vertical groove passage part Vg that allows communication between the hollowed-out passage part 125e of the first outer circumferential surface 120a₁ and the hollowed-out passage part 126e of the second outer circumferential surface 120a₂, and the hollowed-out passage part 125f of the first outer circumferential surface 120a₁ and the hollowed-out passage part 126h of the second outer circumferential surface 120a₂ that are formed to communicate with the vertical groove passage part Vg.

The contact part 127, as shown in FIG. 8, contacts the stopper 101f formed on the bottom wall 101d of the cylindrical recess 101 of the base member 100 to restrict rotation of the multi-way switching valve 120. That is, the multi-way switching valve 120 rotates clockwise CW and counterclockwise CCW around the axis S to contact the stopper 101f, and further rotation of the multi-way switching valve 120 is restricted.

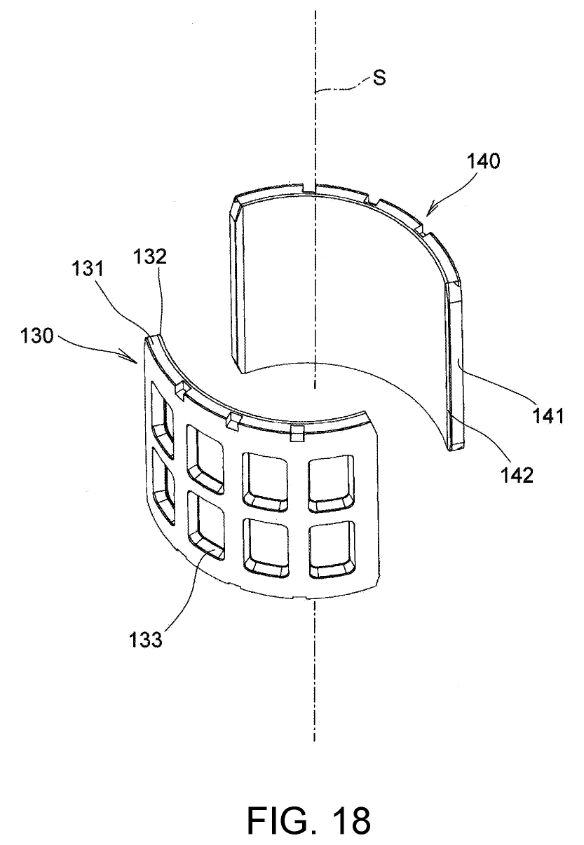

The seal member 130, as shown in FIG. 18, is assembled in an arc plate shape centered on the axis S, and includes an outer arc plate 131 formed of rubber material, an inner arc plate 132 formed of crystalline resin material, for example fluorine resin such as polytetrafluoroethylene (PTFE), and a plurality of (here, eight) substantially rectangular holes 133.

The plurality of rectangular holes 133 are each formed to correspond to the plurality of openings (first inlet 102a, first outlet 103a, second inlet 104a, second outlet 105a, third inlet 106a, third outlet 107a, fourth inlet 108a, fourth outlet 109a) formed on the inner circumferential surface 101a of the cylindrical part 101.

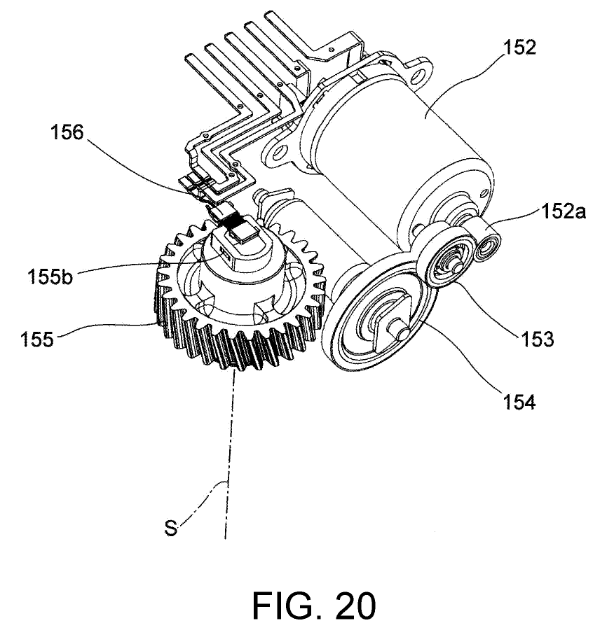

Moreover, the seal member 130, as shown in FIGS. 8 and 20, is disposed between the inner circumferential surface 101a of the cylindrical recess 101 of the base member 100 and the outer circumferential surface 120a of the multi-way switching valve 120 at a position corresponding to the angle range θ1 between the pair of projection parts 101b.

The spacer member 140, as shown in FIG. 18, is assembled in an arc plate shape centered on the axis S, and includes an outer arc plate 141 formed of rubber material and an inner arc plate 142 formed of crystalline resin material, for example fluorine resin such as polytetrafluoroethylene (PTFE).

The spacer member 140, as shown in FIGS. 8 and 19 , is disposed between the inner circumferential surface 101a of the cylindrical recess 101 of the base member 100 and the outer circumferential surface 120a of the multi-way switching valve 120 at a position corresponding to the angle range θ2 between the pair of projection parts 101c, that is, in a region on the opposite side of the seal member 130 across the axis S.

In this way, since the seal member 130 and the spacer member 140 are disposed to face each other across the axis S, an alignment effect of the multi-way switching valve 120 may be obtained, and sliding resistance can be reduced compared to a case where seal members are disposed over the entire circumference, thereby reducing the driving force of the multi-way switching valve 120.

The drive unit 150, as shown in FIGS. 19 and 20 , includes a housing 151, a motor 152 having a drive gear 152a, speed reduction gears 153, 154, a gear 155, and a Hall IC 156.

The housing 151 surrounds the entirety except for a connection hole 155a of the gear 155, and is configured by a housing body 151a and a housing cover 151b, and includes three boss parts 151a1 through which the screws b2 pass, as shown in FIG. 20.

The motor 152 is, for example, a DC motor, and is driven by a low-voltage battery.

The gear 155 includes the connection hole 155a to which the end part 121b of the rotating shaft 121 is connected, and a detected part 155b that includes and is embedded with permanent magnets and the like.

The Hall IC 156 is disposed on the housing cover 151b to face the detected part 155b, and is configured to detect the rotational position of the multi-way switching valve 120.

The drive unit 150 having the above configuration is joined to the outside of the cover member 110 from the axis S direction, and is fixed to the cover member 110 by the screws b2.

The water pump 160 is an electric centrifugal pump driven by a low-voltage battery, and as shown in FIG. 5, includes a fitting flange part 161 and two boss parts 161a through which screws b1 pass. Moreover, the water pump 160 is disposed in the first pump accommodation recess 102c of the base member 100 from the axis S direction, the fitting flange part 161 is joined to the flange part 102c1, and is fixed to the base member 100 by the screws b1.

The water pump 170 is an electric centrifugal pump driven by a low-voltage battery, and as shown in FIG. 5, includes a fitting flange part 171 and two boss parts 171a through which the screws b1 pass. The water pump 170 is disposed in the second pump accommodation recess 104c of the base member 100 from the axis S direction, the fitting flange part 171 is joined to the flange part 104c1 and is fixed to the base member 100 by the screws b1.

The reservoir tank 180 adjusts internal pressure that varies according to temperature changes of the cooling water through the cooling water, and as shown in FIG. 5, includes a passage part 181 that forms an internal passage (not shown) communicating with the branch port 105c, and two boss parts 182 through which the screws b1 pass. The reservoir tank 180 is joined to communicate with the branch port 105c from the axis S direction, and is fixed to the base member 100 by the screws b1 via the boss parts 182.

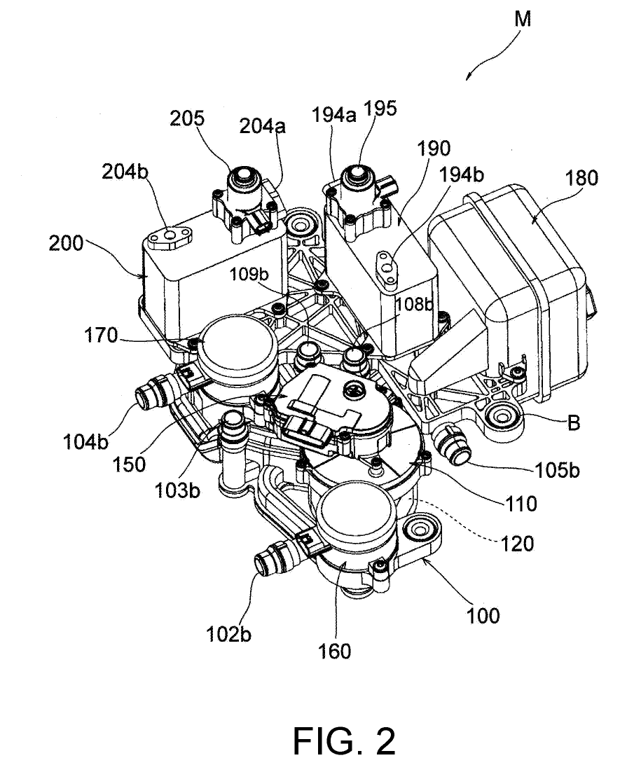

The first refrigerant-heat medium heat exchanger 190, as shown in FIGS. 1 and 2 , performs heat exchange between the refrigerant flowing through the refrigerant passage Rp and the cooling water flowing through the second heat medium passage Fp₂, and is disposed in the base member 100 on the downstream side of the reservoir tank 180 in the second outlet side passage 105.

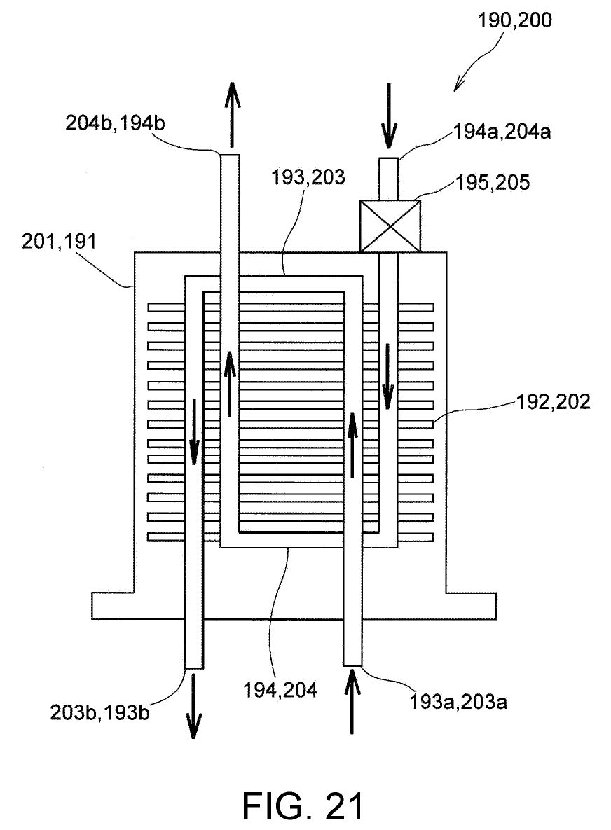

The first refrigerant-heat medium heat exchanger 190, as shown in FIGS. 5 and 21 , includes a housing 191; a heat exchange part 192 in which a plurality of metal plates with high heat conductivity are disposed within the housing 191; an intermediate passage 193 that forms part of the second heat medium passage Fp₂, namely the second outlet side passage 105; a first refrigerant passage 194 that forms part of the refrigerant passage Rp; and an on-off valve 195 disposed on the upstream side of the first refrigerant passage 194.

The housing 191 includes four boss parts 191a through which the screws b1 pass, an inlet joint part 193a and an outlet joint part 193b of the intermediate passage 193, and an inlet connection part 194a and an outlet connection part 194b of the first refrigerant passage 194.

The on-off valve 195 is a solenoid valve driven by a low-voltage battery, and opens and closes the upstream side of the first refrigerant passage 194.

The second refrigerant-heat medium heat exchanger 200, as shown in FIGS. 1 and 2 , performs heat exchange between the refrigerant flowing through the refrigerant passage Rp and the cooling water flowing through the third heat medium passage Fp₃, and is disposed in the base member 100 between the third inlet side passage 106 and the third outlet side passage 107.

The second refrigerant-heat medium heat exchanger 200, as shown in FIGS. 5 and 21 , includes a housing 201, a heat exchange part 202 in which a plurality of metal plates with high heat conductivity are disposed within the housing 201, an intermediate passage 203 that connects the third inlet side passage 106 and the third outlet side passage 107, a second refrigerant passage 204 that forms part of the refrigerant passage Rp, and an expansion valve 205 disposed on the upstream side of the second refrigerant passage 204.

The housing 201 includes four boss parts 201a through which the screws b1 pass, an inlet joint part 203a and an outlet joint part 203b of the intermediate passage 203, and an inlet connection part 204a and an outlet connection part 204b of the second refrigerant passage 204.

The expansion valve 205 is a solenoid valve driven by a low-voltage battery, and opens the upstream side of the second refrigerant passage 204 to expand the refrigerant.

Next, the assembly work of the multi-way switching valve device M having the above configuration will be described.

As shown in FIG. 5, the base member 100, cover member 110, multi-way switching valve 120, seal member 130, spacer member 140, drive unit 150, water pumps 160, 170, reservoir tank 180, first refrigerant-heat medium heat exchanger 190, second refrigerant-heat medium heat exchanger 200, O-rings Sr₁, Sr₂, and a plurality of screws b1, b2 are prepared in advance.

First, the seal member 130 and spacer member 140 are respectively disposed between the pair of projection parts 101b, 101c in the cylindrical recess 101 of the base member 100 from the axis S direction.

Subsequently, the multi-way switching valve 120 with the O-ring Sr₂ attached is inserted into the cylindrical recess 101 from the axis S direction, while the end part 121a is inserted into the bearing recess 101e.

Subsequently, the O-ring Sr₁ is fitted into the annular seal groove 101h of the flange part 101g, and the cover member 110 is joined to the flange part 101g of the base member 100 from the axis S direction and fixed by the screws b2. In this assembled state, the end part 121b of the multi-way switching valve 120 is exposed to the outside through the circular hole 111.

Subsequently, the drive unit 150 is brought close to the cover member 110 from the axis S direction, and is fixed to the cover member 110 by the screws b2 while fitting the end part 121b into the connection hole 155a of the gear 155.

Subsequently, the water pump 160 is fitted into the first pump accommodation recess 102c of the base member 100 from the axis S direction and fixed by the screws b1.

Subsequently, the water pump 170 is fitted into the second pump accommodation recess 104c of the base member 100 from the axis S direction and fixed by the screws b1.

Subsequently, the reservoir tank 180 is joined to the base member 100 from the axis S direction so as to communicate with the branch port 105c and fixed by the screws b1.

Subsequently, the first refrigerant-heat medium heat exchanger 190 is joined to the base member 100 from the axis S direction such that the two separation ports 105d, 105e and the intermediate passage 193 communicate, and is fixed by the screws b1.

Subsequently, the second refrigerant-heat medium heat exchanger 200 is joined to the base member 100 from the axis S direction and is fixed by the screws b1 such that the third downstream port 106b and the third upstream port 107b communicate with the intermediate passage 203.

The assembly sequence is not limited to the above procedure, and other procedures may be adopted.

In this manner, since various components (the cover member 110, the multi-way switching valve 120, the seal member 130, the spacer member 140, the drive unit 150, the water pumps 160, 170, the reservoir tank 180, the first refrigerant-heat medium heat exchanger 190, the second refrigerant-heat medium heat exchanger 200) may be assembled to the base member 100 from one side in the axis S direction, setup during assembly can be reduced, and therefore assembly man-hours can be reduced.

Moreover, by adopting the assembly method from one side in the axis S direction, a plurality of passages (the first inlet side passage 102, the first outlet side passage 103, the second inlet side passage 104, the second outlet side passage 105, the third inlet side passage 106, the third outlet side passage 107, the fourth inlet side passage 108, the fourth outlet side passage 109) may be disposed radially around the cylindrical recess 101 with respect to the base member 100 and formed integrally, thereby achieving integrated arrangement of the arrangement structure, reduction in the number of components, thinning of the device in the axis S direction, and the like.

Next, the operation of the temperature control system including the multi-way switching valve device M will be described.

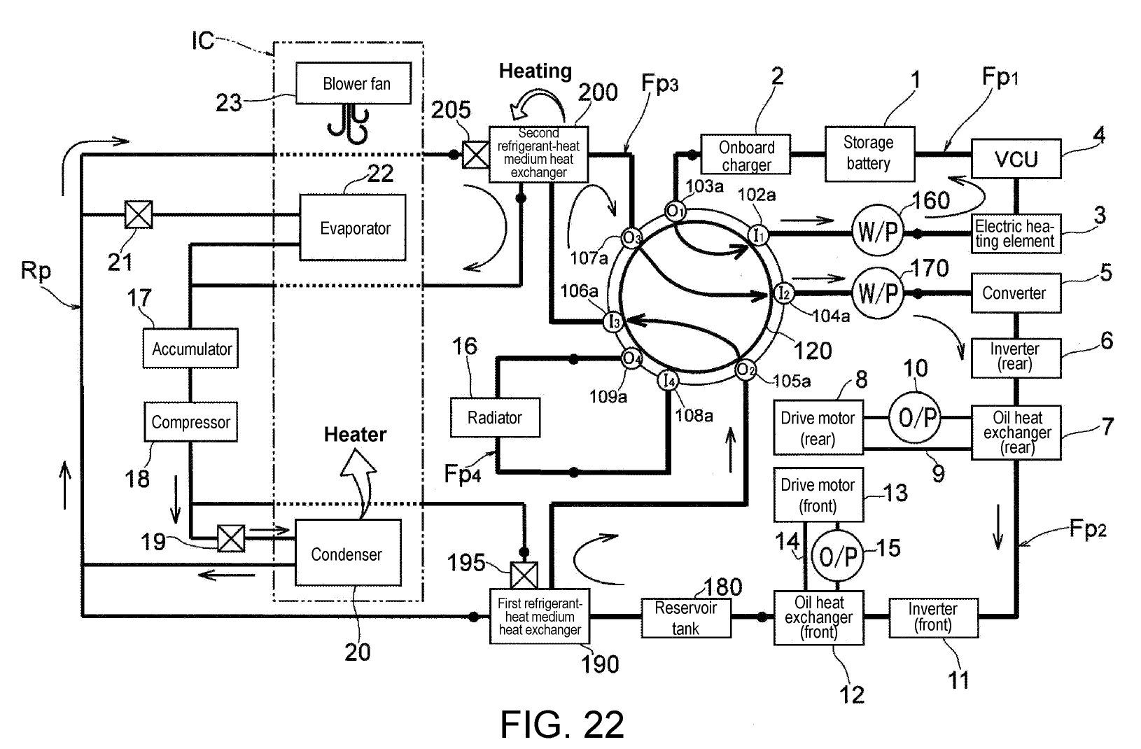

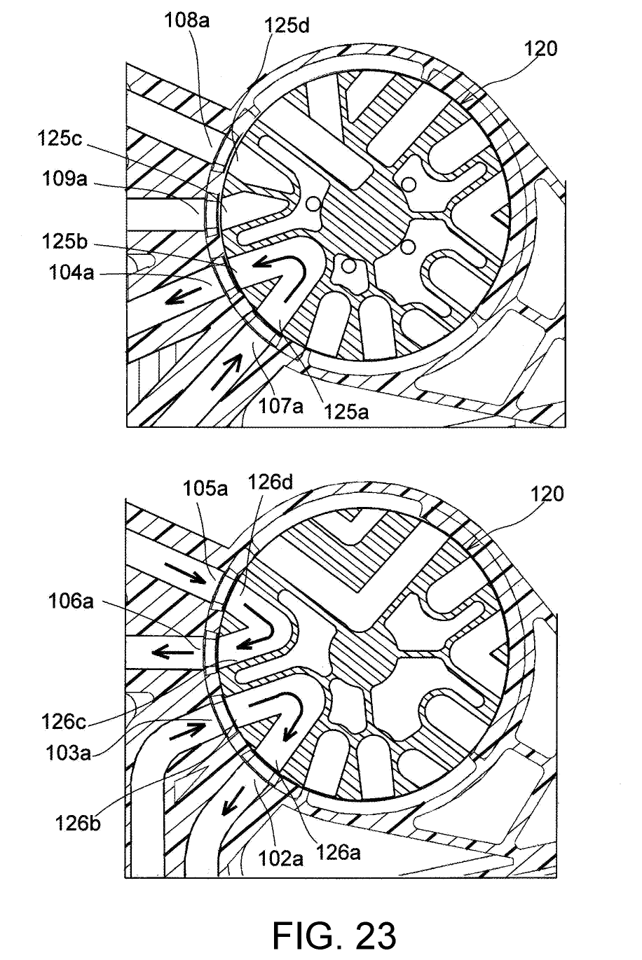

In the case of the multi-way switching valve 120 being positioned at the first switching position, as shown in FIGS. 22 and 23 , the first outlet side passage 103 and the first inlet side passage 102 are brought into communication by connecting the first outlet 103a (outlet O₁) and the first inlet 102a (inlet I₁) to oppose the hollowed-out passage parts 126b, 126a respectively, the third outlet side passage 107 and the second inlet side passage 104 are brought into communication by connecting the third outlet 107a (outlet O₃) and the second inlet 104a (inlet I₂) to oppose the hollowed-out passage parts 125a, 125b respectively, the second outlet side passage 105 and the third inlet side passage 106 are brought into communication by connecting the second outlet 105a (outlet O₂) and the third inlet 106a (inlet I₃) to oppose the hollowed-out passage parts 126d, 126c respectively, and the fourth inlet side passage 108 and the fourth outlet side passage 109 are blocked by connecting the fourth inlet 108a (inlet I₄) and the fourth outlet 109a (outlet O₄) to oppose the hollowed-out passage parts 125d, 125c respectively.

Therefore, the first heat medium passage Fp₁ forms a closed loop passage, and the second heat medium passage Fp₂ and the third heat medium passage Fp₃ are connected in series to form a closed loop passage. Accordingly, by energizing the electric heating element 3 to generate heat, the cooling water in the first heat medium passage Fp₁ may be heated, and the storage battery 1 may be heated by the heated cooling water.

Moreover, the cooling water heated by the heat generated from the rear drive motor 8 and the front drive motor 13 (or the heat emitted from the converter 5, inverters 6, 11) may be guided to the third heat medium passage Fp₃.

Therefore, as operation mode 1, with the on-off valve 195 and expansion valve 21 closed (OFF), the on-off valve 19 is opened (ON), the compressor 18 is started, and the expansion valve 205 is opened, whereby in the second refrigerant-heat medium heat exchanger 200, the refrigerant is heated by the cooling water, and the cabin IC may be heated by the heat released from the condenser 20. In this operation mode 1, in the case of low outside air temperature, for example, in an environment of -10°C or below, the storage battery 1 may be heated to an appropriate temperature while suppressing the power consumption of the storage battery 1, and the waste heat generated by the drive motor may be recovered to heat the refrigerant, thereby improving the heating efficiency in the cabin IC.

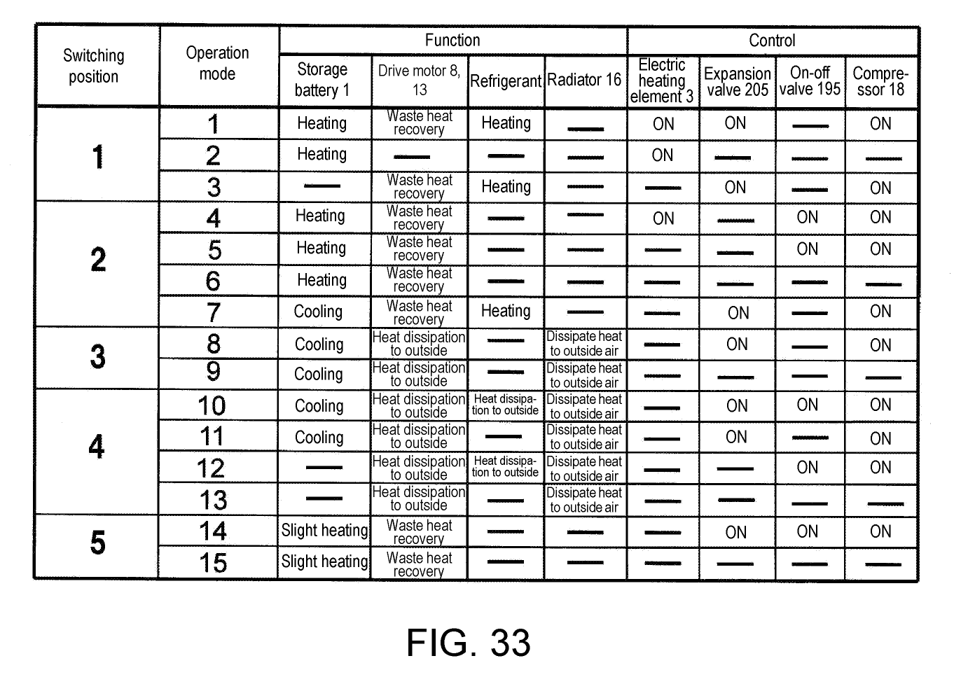

Moreover, at the first switching position, as shown in FIG. 33, operation modes 2 and 3 are set as other operation modes.

In operation mode 2, the electric heating element 3 is tuned ON, the on-off valve 195 of the first refrigerant-heat medium heat exchanger 190 is turned OFF, the expansion valve 205 of the second refrigerant-heat medium heat exchanger 200 is turned OFF, and the compressor 18 is turned OFF, thereby heating the storage battery 1.

In operation mode 3, the electric heating element 3 is turned OFF, the expansion valve 205 of the second refrigerant-heat medium heat exchanger 200 is turned ON, and the compressor 18 is turned ON, thereby heating the refrigerant.

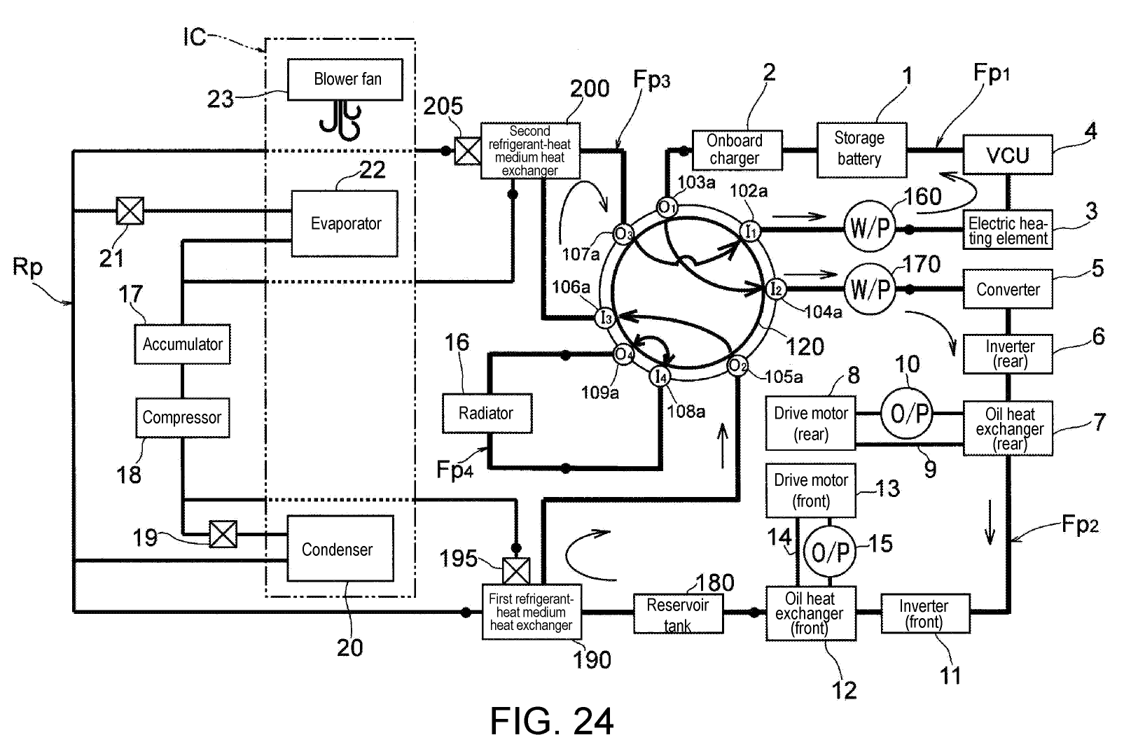

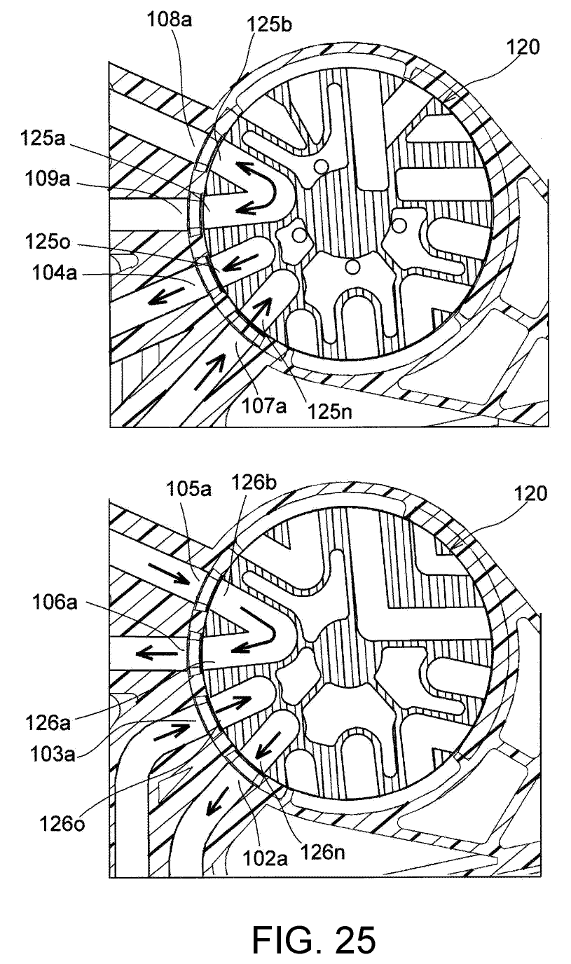

In the case of the multi-way switching valve 120 being positioned at the second switching position, as shown in FIGS. 24 and 25 , the first outlet side passage 103 and the second inlet side passage 104 are brought into communication by connecting the first outlet 103a (outlet O₁) and the second inlet 104a (inlet I₂) to oppose the hollowed-out passage parts 126o, 125o respectively, the third outlet side passage 107 and the first inlet side passage 102 are brought into communication by connecting the third outlet 107a (outlet O₃) and the first inlet 102a (inlet I₁) to oppose the hollowed-out passage parts 125n, 126n respectively, the second outlet side passage 105 and the third inlet side passage 106 are brought into communication by connecting the second outlet 105a (outlet O₂) and the third inlet 106a (inlet I₃) to oppose the hollowed-out passage parts 126b, 126a respectively, and the fourth inlet side passage 108 and the fourth outlet side passage 109 are brought into communication by connecting the fourth inlet 108a (inlet I₄) and the fourth outlet 109a (outlet O₄) to oppose the hollowed-out passage parts 125b, 125a respectively.

Therefore, the first heat medium passage Fp₁, the second heat medium passage Fp₂, and the third heat medium passage Fp₃ are connected in series to form a closed loop passage, and the cooling water circulates through the closed loop passage. The fourth heat medium passage Fp₄ forms a closed loop passage with the fourth inlet 108a and the fourth outlet 109a connected, so no circulation of cooling water occurs with respect to the radiator 16.

At the second switching position, as shown in FIG. 33, operation modes 4 to 7 are set.

In operation mode 4, the electric heating element 3 is turned ON, the on-off valve 195 of the first refrigerant-heat medium heat exchanger 190 is turned ON, the expansion valve 205 of the second refrigerant-heat medium heat exchanger 200 is turned OFF, and the compressor 18 is turned ON, causing the first refrigerant-heat medium heat exchanger 190 to function as a liquid-cooled condenser, and the cooling water is heated by the electric heating element 3 and the refrigerant, thereby heating the storage battery 1.

In operation mode 5, the electric heating element 3 is turned OFF, the on-off valve 195 of the first refrigerant-heat medium heat exchanger 190 is turned ON, the expansion valve 205 of the second refrigerant-heat medium heat exchanger 200 is turned OFF, and the compressor 18 is turned ON, causing the first refrigerant-heat medium heat exchanger 190 to function as a liquid-cooled condenser, and the cooling water is heated by the refrigerant, thereby heating the storage battery 1.

In operation mode 6, the electric heating element 3 is turned OFF, the on-off valve 195 of the first refrigerant-heat medium heat exchanger 190 is turned OFF, the expansion valve 205 of the second refrigerant-heat medium heat exchanger 200 is turned OFF, and the compressor 18 is turned OFF, and the cooling water is heated only by heat generated by heat-generating components (rear drive motor 8, front drive motor 13, etc.), thereby heating the storage battery 1.

In operation mode 7, the electric heating element 3 is turned OFF, the on-off valve 195 of the first refrigerant-heat medium heat exchanger 190 is turned OFF, the expansion valve 205 of the second refrigerant-heat medium heat exchanger 200 is turned ON, and the compressor 18 is turned ON, causing the second refrigerant-heat medium heat exchanger 200 to function as a chiller and the cooling water is cooled, thereby cooling the storage battery 1.

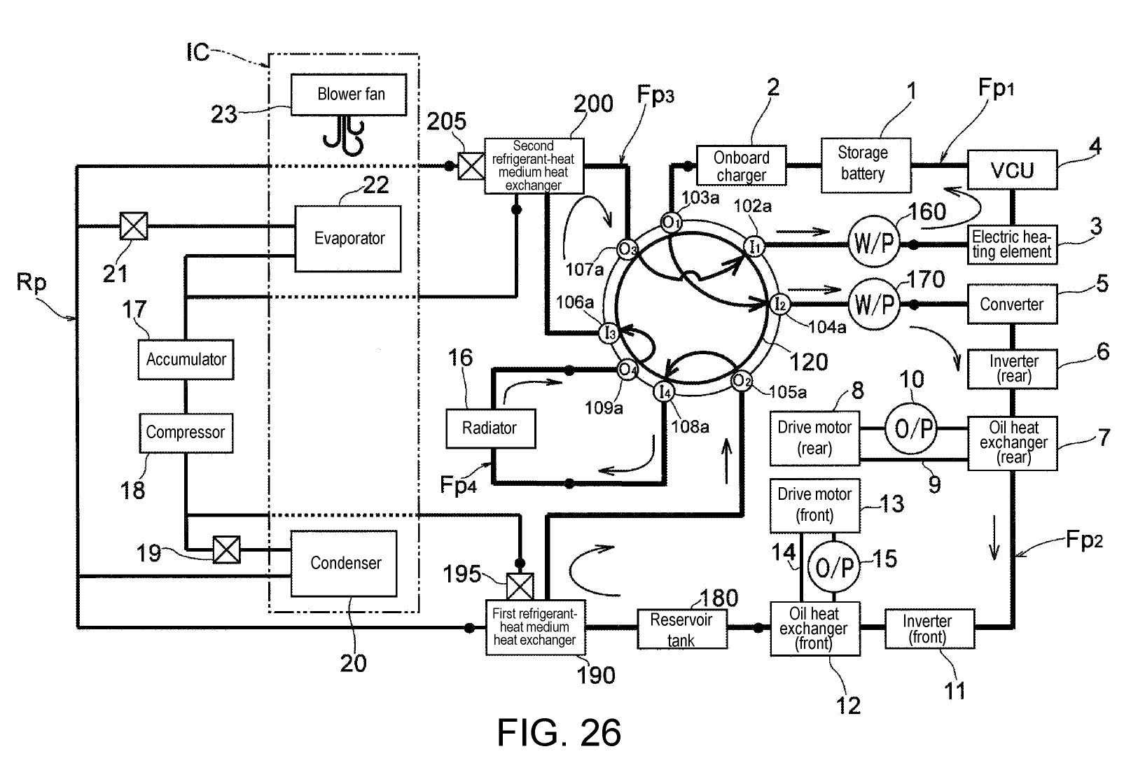

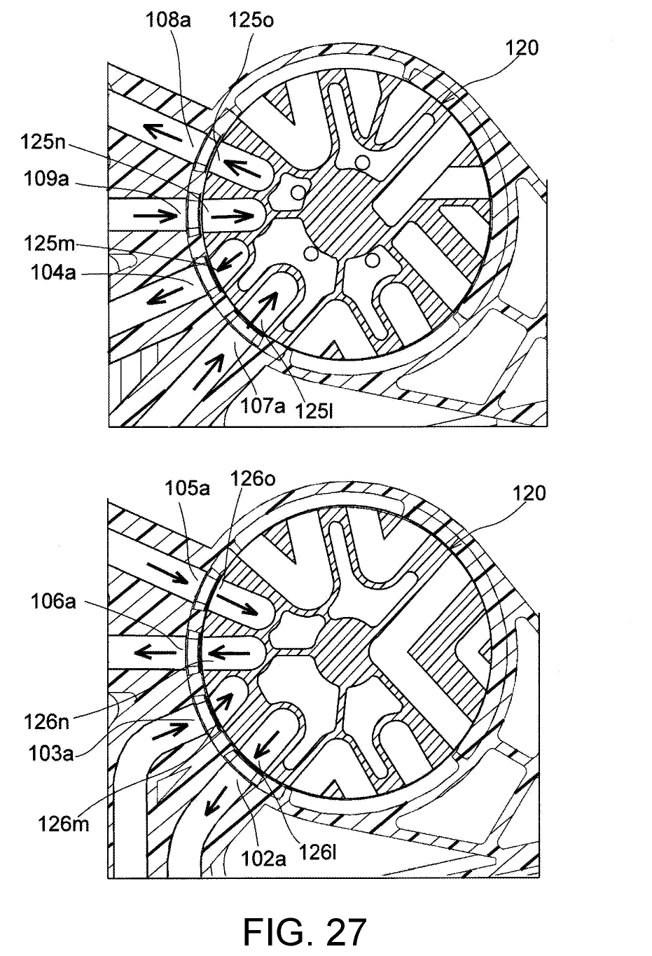

In the case of the multi-way switching valve 120 being positioned at the third switching position, as shown in FIGS. 26 and 27 , the first outlet side passage 103 and the second inlet side passage 104 are brought into communication by connecting the first outlet 103a (outlet O₁) and the second inlet 104a (inlet I₂) to oppose the hollowed-out passage parts 126m, 125m respectively, the third outlet side passage 107 and the first inlet side passage 102 are brought into communication by connecting the third outlet 107a (outlet O₃) and the first inlet 102a (inlet I₁) to oppose the hollowed-out passage parts 125l, 126l respectively, the second outlet side passage 105 and the fourth inlet side passage 108 are brought into communication by connecting the second outlet 105a (outlet O₂) and the fourth inlet 108a(I₄) to oppose the hollowed-out passage parts 126o, 125o respectively, and the fourth outlet side passage 109 and the third inlet side passage 106 are brought into communication by connecting the fourth outlet 109a (outlet O₄) and the third inlet 106a (inlet I₃) to oppose the hollowed-out passage parts 125n, 126n respectively.

Therefore, the first heat medium passage Fp₁, the second heat medium passage Fp₂, the fourth heat medium passage Fp₄, and the third heat medium passage Fp₃ are connected in series to form a closed loop passage, and the cooling water circulates through the closed loop passage.

At the third switching position, as shown in FIG. 33, operation modes 8 and 9 are set.

In operation mode 8, the electric heating element 3 is turned OFF, the on-off valve 195 of the first refrigerant-heat medium heat exchanger 190 is turned OFF, the expansion valve 205 of the second refrigerant-heat medium heat exchanger 200 is turned ON, and the compressor 18 is turned ON, causing the second refrigerant-heat medium heat exchanger 200 to function as a chiller to cool the cooling water, and also heat is released to the outside at the radiator 16, thereby cooling the storage battery 1 and heat-generating components (rear drive motor 8, front drive motor 13, etc.).

In operation mode 9, the electric heating element 3 is turned OFF, the on-off valve 195 of the first refrigerant-heat medium heat exchanger 190 is turned OFF, the expansion valve 205 of the second refrigerant-heat medium heat exchanger 200 is turned OFF, and the compressor 18 is turned OFF, and heat is released to the outside at the radiator 16, thereby cooling the storage battery 1 and heat-generating components (rear drive motor 8, front drive motor 13, etc.).

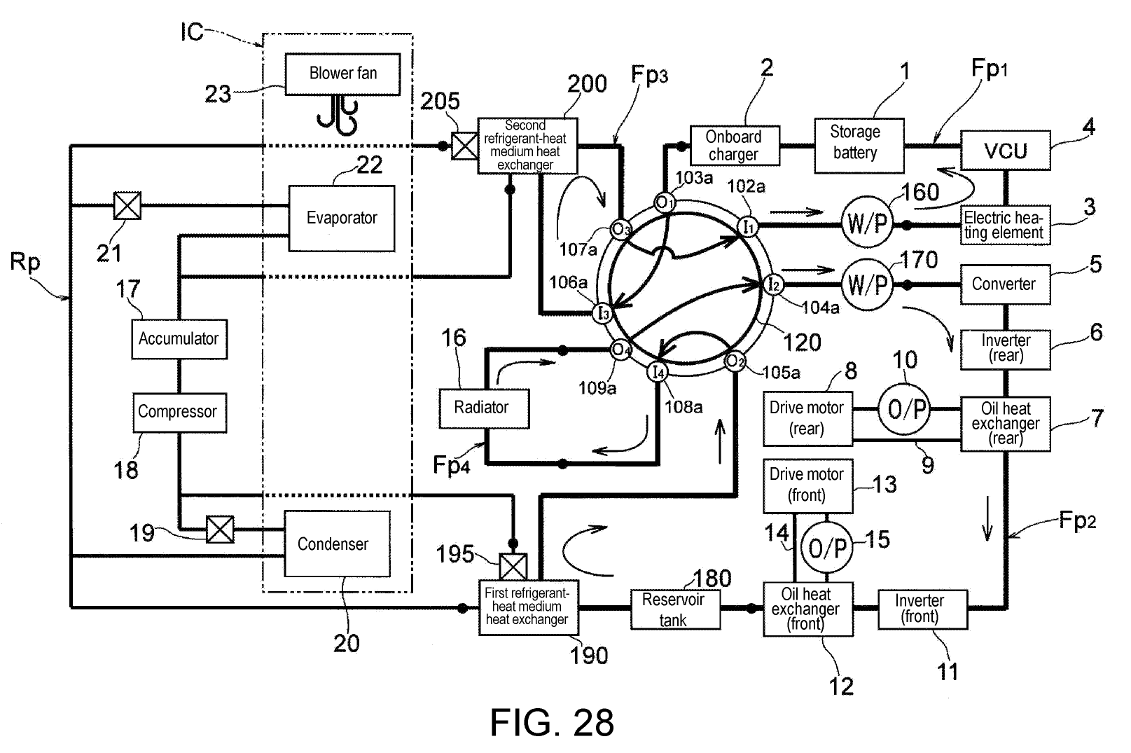

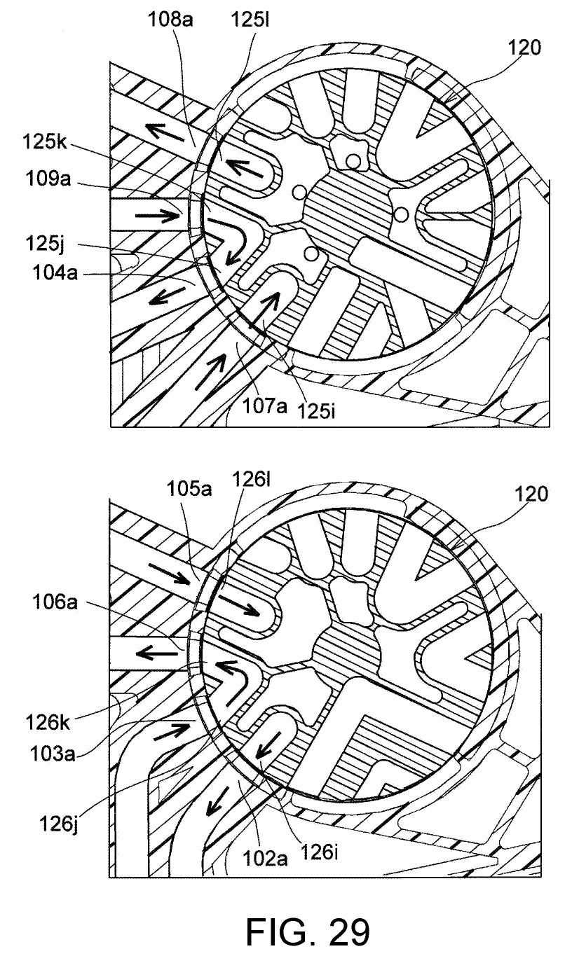

In the case of the multi-way switching valve 120 being positioned at the fourth switching position, as shown in FIGS. 28 and 29 the first outlet side passage 103 and the third inlet side passage 106 are brought into communication by connecting the first outlet 103a (outlet O₁) and the third inlet 106a(inlet I₃) to oppose the hollowed-out passage parts 126j and 126k respectively, the third outlet side passage 107 and the first inlet side passage 102 are brought into communication by connecting the third outlet 107a (outlet O₃) and the first inlet 102a (inlet I₁) to oppose the hollowed-out passage parts 125i and 126i respectively, the second outlet side passage 105 and the fourth inlet side passage 108 are brought into communication by connecting the second outlet 105a(outlet O₂) and the fourth inlet 108a (inlet I₄) to oppose the hollowed-out passage parts 126l and 125l respectively, and the fourth outlet side passage 109 and the second inlet side passage 104 are brought into communication by connecting the fourth outlet 109a (outlet O₄) and the second inlet 104a(inlet I₂) to oppose the hollowed-out passage parts 125k and 125j respectively.

Therefore, the first heat medium passage Fp₁ and the third heat medium passage Fp₃ are connected in series to form a closed loop passage, the second heat medium passage Fp₂ and the fourth heat medium passage Fp₄ are connected in series to form a closed loop passage, and the cooling water circulates through the respective closed loop passages.

At the fourth switching position, as shown in FIG. 33, operation modes 10 to 13 are set.

In operation mode 10, the electric heating element 3 is turned OFF, the on-off valve 195 of the first refrigerant-heat medium heat exchanger 190 is turned ON, the expansion valve 205 of the second refrigerant-heat medium heat exchanger 200 is turned ON, and the compressor 18 is turned ON, causing the first refrigerant-heat medium heat exchanger 190 to function as a liquid-cooled condenser to release heat from the refrigerant to the cooling water, causing the second refrigerant-heat medium heat exchanger 200 to function as a chiller to cool the cooling water, and heat is released to the outside at the radiator 16, thereby cooling the storage battery 1 and heat-generating components (rear drive motor 8, front drive motor 13, etc.).

In operation mode 11, the electric heating element 3 is turned OFF, the on-off valve 195 of the first refrigerant-heat medium heat exchanger 190 is turned OFF, the expansion valve 205 of the second refrigerant-heat medium heat exchanger 200 is turned ON, and the compressor 18 is turned ON, causing the second refrigerant-heat medium heat exchanger 200 to function as a chiller to cool the cooling water, and heat is released to the outside at the radiator 16, thereby cooling the storage battery 1 and heat-generating components (rear drive motor 8, front drive motor 13, etc.).

In operation mode 12, the electric heating element 3 is turned OFF, the on-off valve 195 of the first refrigerant-heat medium heat exchanger 190 is turned ON, the expansion valve 205 of the second refrigerant-heat medium heat exchanger 200 is turned OFF, and the compressor 18 is turned ON, causing the first refrigerant-heat medium heat exchanger 190 to function as a liquid-cooled condenser to release heat from the refrigerant to the cooling water, and heat is released to the outside at the radiator 16, thereby cooling the heat-generating components (rear drive motor 8, front drive motor 13, etc.).

In operation mode 13, the electric heating element 3 is turned OFF, the on-off valve 195 of the first refrigerant-heat medium heat exchanger 190 is turned OFF, the expansion valve 205 of the second refrigerant-heat medium heat exchanger 200 is turned OFF, and the compressor 18 is turned OFF, and heat is released to the outside at the radiator 16, thereby cooling the heat-generating components (rear drive motor 8, front drive motor 13, etc.).

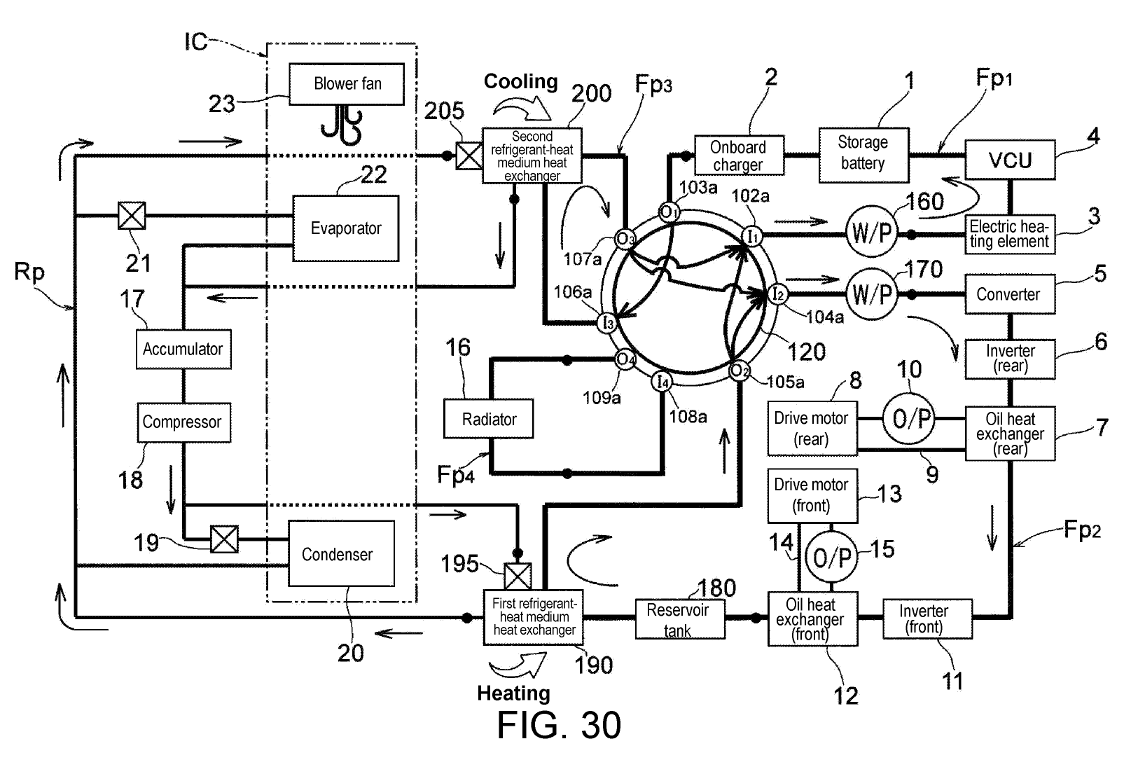

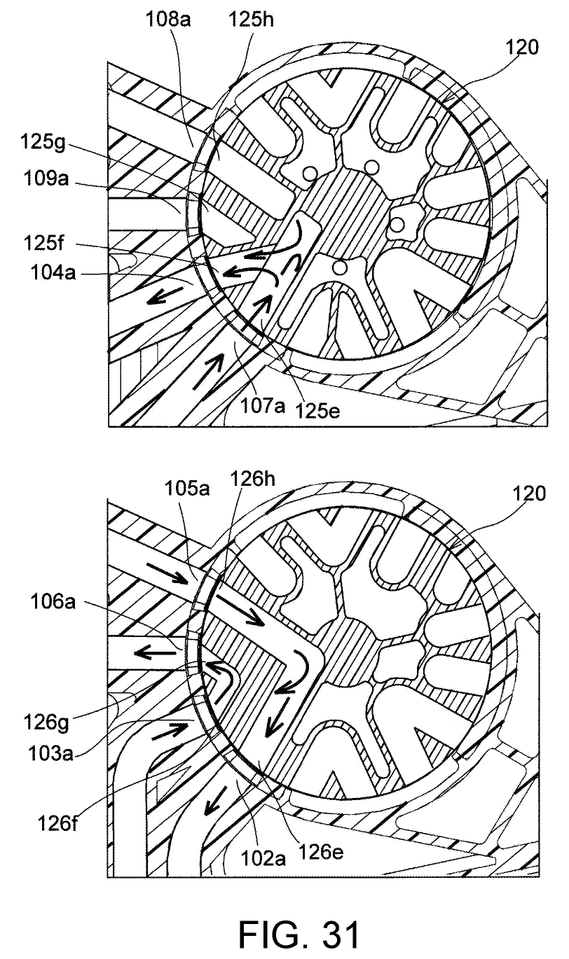

In the case of the multi-way switching valve 120 being positioned at the fifth switching position as a mixing switching position that mixes cooling water as fluid having different state quantities (here, temperature), as shown in FIGS. 30 and 31 , the first outlet side passage 103 and the third inlet side passage 106 are brought into communication by connecting the first outlet 103a (outlet O₁) and the third inlet 106a (inlet I₃) to oppose the hollowed-out passage parts 126f and 126g respectively, the third outlet side passage 107 and the first inlet side passage 102 and the second inlet side passage 104 are brought into communication by connecting the third outlet 107a (outlet O₃) and the first inlet 102a (inlet I₁) and the second inlet 104a (inlet I₂) to oppose the hollowed-out passage parts 125e, 126e, and 125f respectively, the second outlet side passage 105 and the first inlet side passage 102 and the second inlet side passage 104 are brought into communication by connecting the second outlet 105a (outlet O₂) and the first inlet 102a (inlet I₁) and the second inlet 104a (inlet I₂) to oppose the hollowed-out passage parts 126h, 126e, and 125f respectively, and the fourth inlet side passage 108 and the fourth outlet side passage 109 are blocked by connecting the fourth inlet 108a (inlet I₄) and the fourth outlet 109a (outlet O₄) to oppose the hollowed-out passage parts 125h and 125g respectively.

Therefore, the first heat medium passage Fp₁ and the third heat medium passage Fp₃ are connected in series to form a closed loop passage, the first heat medium passage Fp₁, the third heat medium passage Fp₃, and the second heat medium passage Fp₂ are connected in series to form a closed loop passage, and the second heat medium passage Fp₂ forms a closed loop passage that circulates by itself, and the cooling water circulates through the respective closed loop passages.

At the fifth switching position, as shown in FIG. 33, operation modes 14 and 15 are set.

In operation mode 14, the electric heating element 3 is turned OFF, the on-off valve 195 of the first refrigerant-heat medium heat exchanger 190 is turned ON, the expansion valve 205 of the second refrigerant-heat medium heat exchanger 200 is turned ON, and the compressor 18 is turned ON, causing the first refrigerant-heat medium heat exchanger 190 to function as a liquid-cooled condenser to release heat from the refrigerant to the cooling water, and causing the second refrigerant-heat medium heat exchanger 200 to function as a chiller to cool the cooling water, thereby moderately heating (slightly heating) the storage battery 1. In this way, by appropriately heating and cooling the cooling water, it is possible to prevent the temperature of the storage battery 1 from becoming unstable and maintain the storage battery 1 at an appropriate management temperature.

In operation mode 15, the electric heating element 3 is turned OFF, the on-off valve 195 of the first refrigerant-heat medium heat exchanger 190 is turned OFF, the expansion valve 205 of the second refrigerant-heat medium heat exchanger 200 is turned OFF, and the compressor 18 is turned OFF, and the cooling water is heated with heat recovered from heat-generating components (rear drive motor 8, front drive motor 13, etc.), thereby moderately heating (slightly heat) the storage battery 1.

In this way, for example, while suppressing the amount of heat generated by the electric heating element 3, heat (waste heat) emitted from heat-generating components (converter 5, inverters 6 and 11, rear drive motor 8, front drive motor 13) may be utilized to adjust the cooling water in the first heat medium passage Fp₁ to an optimal temperature and heat (slightly heat) the storage battery 1 to an appropriate temperature.

If the amount of heat generated by the electric heating element 3 is increased, the time for the storage battery 1 to reach an appropriate temperature becomes shorter, but overshoot exceeding the allowable upper limit temperature occurs, the frequency of switching to cooling mode increases, which may cause complicated control and instability of the storage battery 1. Therefore, by mixing and flowing cooling water having different state quantities (temperatures) as described above, the cooling water may be adjusted to an optimal temperature for the storage battery 1, conventional overshoot may be avoided, switching frequency may be reduced, and the storage battery 1 may be maintained at a stable temperature.

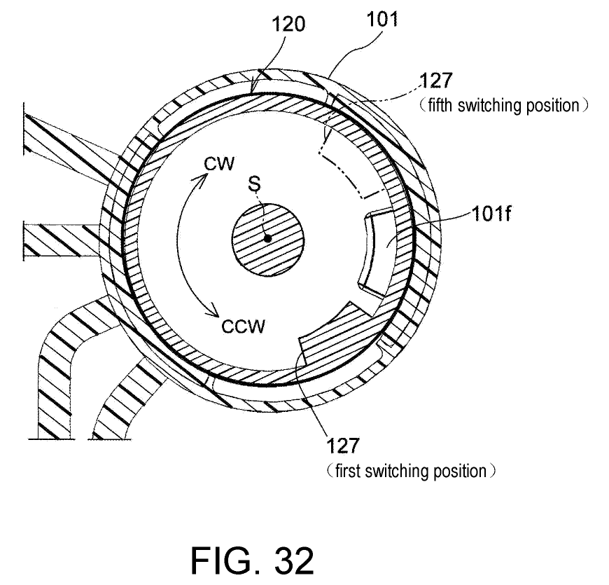

As described above, the multi-way switching valve 120 is appropriately switched from the first switching position to the fifth switching position, and as shown in FIG. 32, in response to the position of the contact part 127 indicated by the solid line rotates in one direction (clockwise CW) corresponding to the first switching position, it passes through the second switching position, the third switching position, and the fourth switching position to reach the fifth switching position which is the position of the contact part 127 indicated by the two-dot chain line. In this way, the multi-way switching valve 120 is positioned at a desired switching position while the angular position is detected by the Hall IC 156 by appropriately rotating clockwise (CW) or counterclockwise (CCW) with the stopper 101f as a boundary.

As described above, the multi-way switching valve device of the disclosure includes a base member 100 having a cylindrical recess 101 centered on a predetermined axis S and a plurality of openings formed on an inner circumferential surface 101a of the cylindrical recess 101 within an angle range θ1 narrower than a half circumference to define inlets and outlets of each of a plurality of fluid passages; a columnar multi-way switching valve 120 having a plurality of hollowed-out passage parts on an outer circumferential surface 120a and rotatably disposed in the cylindrical recess 101 around the axis S to perform opening and closing operations of the plurality of openings; a seal member 130 disposed between the inner circumferential surface 101a and the outer circumferential surface 120a corresponding to the angle range θ1; and a spacer member 140 disposed between the inner circumferential surface 101a and the outer circumferential surface 120a in a region on an opposite side of the seal member 130 across the axis S.

According to this configuration, the seal member 130 and the spacer member 140 may be inserted into the cylindrical recess 101 from one side in the axis S direction, and the multi-way switching valve 120 may be inserted and assembled. Moreover, since the seal member 130 and the spacer member 140 are disposed to face each other across the axis S, an alignment effect of the multi-way switching valve 120 can be obtained, and sliding resistance can be reduced compared to a case where seal members are disposed over the entire circumference, thereby reducing the driving force of the multi-way switching valve 120.

Moreover, the seal member 130 and the spacer member 140 are formed such that the side contacting the inner circumferential surface 101a is formed of rubber material, and the side contacting the outer circumferential surface 120a is formed of crystalline resin material, for example, fluorine resin such as polytetrafluoroethylene (PTFE).

According to this configuration, the sealing performance between the inner circumferential surface 101a and the seal member 130 can be enhanced, and the multi-way switching valve 120 can be held while applying elastic force between the seal member 130 and the spacer member 140. On the other hand, the sliding performance of the outer circumferential surface 120a of the multi-way switching valve 120 can be enhanced.

Moreover, the base member 100 includes, as a plurality of fluid passages, a first inlet side passage 102 and a first outlet side passage 103 of a first fluid passage, a second inlet side passage 104 and a second outlet side passage 105 of a second fluid passage, a third inlet side passage 106 and a third outlet side passage 107 of a third fluid passage, and a fourth inlet side passage 108 and a fourth outlet side passage 109 of a fourth fluid passage; inlets 102a, 104a, 106a, 108a of each of the first inlet side passage 102, the second inlet side passage 104, the third inlet side passage 106, and the fourth inlet side passage 108, and outlets 103a, 105a, 107a, 109a of each of the first outlet side passage 103, the second outlet side passage 105, the third outlet side passage 107, and the fourth outlet side passage 109 are formed on the inner circumferential surface 101a.

According to this configuration, since a plurality of inlets and outlets are provided in the angle range θ1 of the inner circumferential surface 101a, a plurality of fluid passages may be disposed in an integrated manner, and thinning and miniaturization of the base member 100 can be achieved.

Moreover, the multi-way switching valve 120 includes a rotating shaft 121 centered on the axis S, and a cover member 110 is fixed to the base member 100 to cover the cylindrical recess 101 while exposing an end part 121b of the rotating shaft 121, in a state where the multi-way switching valve 120 is inserted into the cylindrical recess 101 from the direction of the axis S with the seal member 130 and the spacer member 140 interposed between the inner circumferential surface 101a and the outer circumferential surface 120a.

According to this configuration, after arranging the seal member 130, the spacer member 140, and the multi-way switching valve 120 within the cylindrical recess 101, the cover member 110 may be assembled from one side in the axis S direction, eliminating the need for setup such as direction change during assembly, and assembly man-hours can be reduced.

Moreover, a drive unit 150 that applies driving force to the rotating shaft 121 is included, and the drive unit 150 is fixed to the base member 100 and/or the cover member 110 from the direction of the axis S on the outside of the cover member 110.

According to this configuration, the drive unit 150 may be assembled from one side in the axis S direction, and similarly to the above, setup such as direction change during assembly becomes unnecessary, and assembly man-hours can be reduced.

Moreover, the first fluid passage is a first heat medium passage Fp₁ through which a heat medium that performs heat exchange with the storage battery 1 flows, the second fluid passage is a second heat medium passage Fp₂ through which a heat medium that performs heat exchange with drive motors 8, 13 that drive wheels flows, the third fluid passage is a third heat medium passage Fp₃ through which a heat medium that performs heat exchange with refrigerant circulating through the refrigerant passage Rp flows, and the fourth fluid passage is a fourth heat medium passage Fp₄ through which a heat medium that performs heat exchange with outside air via the radiator 16 flows.

According to this configuration, in a temperature control system for an electric vehicle or the like that includes the first heat medium passage Fp₁, the second heat medium passage Fp₂, the third heat medium passage Fp₃, and the fourth heat medium passage Fp₄, the multi-way switching valve device M having the above configuration may be applied to appropriately adjust the temperature of the heat medium (cooling water) to an appropriate temperature.

Moreover, in the base member 100, a first electric pump (water pump 160) that pressure-feeds the heat medium is disposed in the first inlet side passage 102, and a second electric pump (water pump 170) that pressure-feeds the heat medium is disposed in the second inlet side passage 104.

According to this configuration, the heat medium may be forcibly pressure-fed in the first inlet side passage 102 and the second inlet side passage 104.

Moreover, the first inlet side passage 102 includes a first pump accommodation recess 102c that is formed in the middle thereof and opens in the same direction as the cylindrical recess 101, and the first electric pump (water pump 160) is accommodated in the first pump accommodation recess 102c from the direction of the axis S and fixed to the base member 100, and the second inlet side passage 104 includes a second pump accommodation recess 104c that is formed in the middle thereof and opens in the same direction as the cylindrical recess 101, and the second electric pump (water pump 170) is accommodated in the second pump accommodation recess 104c from the direction of the axis S and fixed to the base member 100.

According to this configuration, the first electric pump and the second electric pump may be assembled from one side in the axis S direction similarly to other components, and similarly to the above, setup such as direction change during assembly becomes unnecessary, and assembly man-hours can be reduced.

Moreover, the base member 100 includes a reservoir tank 180 through which the heat medium passes through in the second outlet side passage 105.

According to this configuration, the internal pressure of the second outlet side passage 105 (second heat medium passage Fp₂) that varies according to temperature changes of the heat medium (cooling water) may be adjusted, and damage to components due to excessive pressure can be prevented.

Moreover, the second outlet side passage 105 includes a branch port 105c in the middle thereof that opens in the same direction as the cylindrical recess 101, and the reservoir tank 180 is fixed to the base member 100 so as to communicate with the branch port 105c from the direction of the axis S.

According to this configuration, the reservoir tank 180 may be assembled from one side in the axis S direction similarly to other components, and similarly to the above, setup such as direction change during assembly becomes unnecessary, and assembly man-hours can be reduced.

Moreover, in the base member 100, a first refrigerant-heat medium heat exchanger 190 that performs heat exchange between the refrigerant and the heat medium is disposed on the downstream side of the reservoir tank 180 in the second outlet side passage 105.

According to this configuration, heat exchange may be performed between the heat medium flowing through the second outlet side passage 105 and the refrigerant flowing through the refrigerant passage Rp via the first refrigerant-heat medium heat exchanger 190, and for example, the first refrigerant-heat medium heat exchanger 190 may function as a liquid-cooled condenser, thereby heating the heat medium.

Moreover, the first refrigerant-heat medium heat exchanger 190 includes a heat exchange part 192, an intermediate passage 193 that forms part of the second heat medium passage Fp₂, and a first refrigerant passage 194 that forms part of the refrigerant passage Rp, and an on-off valve 195 is disposed on the upstream side of the first refrigerant passage 194.

According to this configuration, heat exchange between the refrigerant and the heat medium may be appropriately adjusted by the opening and closing operation of the on-off valve 195.

Moreover, the second outlet side passage 105 includes two separation ports 105d, 105e separated in the middle thereof and open in the same direction as the cylindrical recess 101, and the first refrigerant-heat medium heat exchanger 190 is fixed to the base member 100 from the direction of the axis S such that the two separation ports 105d, 105e communicate with the intermediate passage 193.

According to this configuration, the first refrigerant-heat medium heat exchanger 190 may be assembled from one side in the axis S direction similarly to other components, and similarly to the above, setup such as direction change during assembly becomes unnecessary, and assembly man-hours can be reduced.

Moreover, in the base member 100, a second refrigerant-heat medium heat exchanger 200 that performs heat exchange between the refrigerant and the heat medium is disposed between the third inlet side passage 106 and the third outlet side passage 107.

According to this configuration, heat exchange may be performed between the heat medium flowing through the third heat medium passage (the third inlet side passage 106 and the third outlet side passage 107) and the refrigerant flowing through the refrigerant passage Rp via the second refrigerant-heat medium heat exchanger 200, and for example, the second refrigerant-heat medium heat exchanger 200 may function as a chiller, thereby cooling the heat medium.

Moreover, the second refrigerant-heat medium heat exchanger 200 includes a heat exchange part 202, an intermediate passage 203 that connects the third inlet side passage 106 and the third outlet side passage 107, and a second refrigerant passage 204 that forms part of the refrigerant passage Rp, and an expansion valve 205 is disposed on the upstream side of the second refrigerant passage 204.

According to this configuration, heat exchange between the refrigerant and the heat medium may be appropriately adjusted by the opening and closing operation of the expansion valve 205.

Moreover, the third downstream port 106b of the third inlet side passage 106 and the third upstream port 107b of the third outlet side passage 107 open in the same direction as the cylindrical recess 101, and the second refrigerant-heat medium heat exchanger 200 is fixed to the base member 100 from the direction of the axis S such that the third downstream port 106b and the third upstream port 107b communicate with the intermediate passage 203.

According to this configuration, the second refrigerant-heat medium heat exchanger 200 may be assembled from one side in the axis S direction similarly to other components, and similarly to the above, setup such as direction change during assembly becomes unnecessary, and assembly man-hours can be reduced.

In the above embodiment, a case where the multi-way switching valve device is configured to adjust the flow of heat medium (cooling water) as the target fluid has been shown, but the disclosure is not limited thereto, and the device may also be configured to adjust the flow of other fluids.

In the above embodiment, a case where the drive unit 150 is fixed to the cover member 110 has been shown, but the disclosure is not limited thereto, and the drive unit may be fixed to the base member 100, or may be fixed to both the cover member 110 and the base member 100.

In the above embodiment, a configuration in which the first electric pump (water pump 160) is disposed in the first inlet side passage 102 of the first heat medium passage Fp₁ has been shown, but the disclosure is not limited thereto, and a form that does not employ the first electric pump may be adopted as long as the passage and structure allow natural circulation to occur due to the temperature gradient of the heat medium.

In the above embodiment, a configuration in which the second electric pump (water pump 170) is disposed in the second inlet side passage 104 of the second heat medium passage Fp₂ has been shown, but the disclosure is not limited thereto, and a form that does not employ the second electric pump may be adopted as long as the passage and structure allow natural circulation to occur due to the temperature gradient of the heat medium.

As described above, the multi-way switching valve device of the disclosure can achieve reduction and simplification of man-hours in assembly work, reduction in the number of components, weight reduction, miniaturization and space saving through integrated arrangement of components, reduction of friction resistance during driving, and the like. Therefore, the device is not only applicable to electric vehicles and the like, but is also useful in systems in other fields or other equipment.

What is claimed is:

1. A multi-way switching valve device, comprising:
a base member having a cylindrical recess centered on a predetermined axis and a plurality of openings formed on an inner circumferential surface of the cylindrical recess within an angle range narrower than a half circumference to define an inlet and an outlet of each of a plurality of fluid passages;
a columnar multi-way switching valve having a plurality of hollowed-out passage parts on an outer circumferential surface and rotatably disposed around the axis in the cylindrical recess to perform opening and closing operations of the plurality of openings;
a seal member disposed between the inner circumferential surface and the outer circumferential surface corresponding to the angle range; and
a spacer member disposed between the inner circumferential surface and the outer circumferential surface in a region on an opposite side of the seal member across the axis.

2. The multi-way switching valve device according to claim 1,
wherein each of the seal member and the spacer member is formed such that a side contacting the inner circumferential surface is formed of rubber material and a side contacting the outer circumferential surface is formed of crystalline resin material.

3. The multi-way switching valve device according to claim 1,
wherein the base member comprises, as the plurality of fluid passages, a first inlet side passage and a first outlet side passage of a first fluid passage, a second inlet side passage and a second outlet side passage of a second fluid passage, a third inlet side passage and a third outlet side passage of a third fluid passage, and a fourth inlet side passage and a fourth outlet side passage of a fourth fluid passage, and
the inlet of each of the first inlet side passage, the second inlet side passage, the third inlet side passage, and the fourth inlet side passage, and the outlet of each of the first outlet side passage, the second outlet side passage, the third outlet side passage, and the fourth outlet side passage are formed on the inner circumferential surface.

4. The multi-way switching valve device according to claim 3,
wherein the multi-way switching valve comprises a rotating shaft centered on the axis, and
the base member has a cover member fixed thereto that covers the cylindrical recess while exposing an end part of the rotating shaft, in a state where the multi-way switching valve is inserted into the cylindrical recess along a direction of the axis such that the seal member and the spacer member are interposed between the inner circumferential surface and the outer circumferential surface.

5. The multi-way switching valve device according to claim 4, comprising a drive unit that applies a driving force to the rotating shaft,
wherein the drive unit is fixed to the base member and/or the cover member along the direction of the axis on an outer side of the cover member.

6. The multi-way switching valve device according to claim 4,
wherein the first fluid passage is a first heat medium passage through which a heat medium that performs heat exchange with a storage battery flows,
the second fluid passage is a second heat medium passage through which a heat medium that performs heat exchange with a drive motor that drives wheels flows,
the third fluid passage is a third heat medium passage through which a heat medium that performs heat exchange with a refrigerant that circulates in a refrigerant passage flows, and
the fourth fluid passage is a fourth heat medium passage through which a heat medium that performs heat exchange with outside air via a radiator flows.

7. The multi-way switching valve device according to claim 6,
wherein in the base member, a first electric pump that pressure-feeds the heat medium is disposed in the first inlet side passage and a second electric pump that pressure-feeds the heat medium is disposed in the second inlet side passage.

8. The multi-way switching valve device according to claim 7,
wherein the first inlet side passage has a first pump accommodation recess that is formed in the middle thereof and opens in a same direction as the cylindrical recess,
the first electric pump is accommodated in the first pump accommodation recess along the direction of the axis and fixed to the base member,
the second inlet side passage has a second pump accommodation recess that is formed in the middle thereof and opens in the same direction as the cylindrical recess, and
the second electric pump is accommodated in the second pump accommodation recess along the direction of the axis and fixed to the base member.

9. The multi-way switching valve device according to claim 6,
wherein in the base member, a reservoir tank through which the heat medium passes is disposed in the second outlet side passage.

10. The multi-way switching valve device according to claim 9,
wherein the second outlet side passage has a branch port in the middle thereof that opens in a same direction as the cylindrical recess, and
the reservoir tank is fixed to the base member so as to communicate with the branch port along the direction of the axis.

11. The multi-way switching valve device according to claim 6,
wherein in the base member, a first refrigerant-heat medium heat exchanger that performs heat exchange between the refrigerant and the heat medium is disposed on a downstream side of a reservoir tank in the second outlet side passage.

12. The multi-way switching valve device according to claim 11,
wherein the first refrigerant-heat medium heat exchanger comprises a heat exchange part, an intermediate passage that forms part of the second heat medium passage, and a first refrigerant passage that forms part of the refrigerant passage, and
an on-off valve is disposed on an upstream side of the first refrigerant passage.

13. The multi-way switching valve device according to claim 12,
wherein the second outlet side passage has two separation ports separated in the middle thereof and open in a same direction as the cylindrical recess, and
the first refrigerant-heat medium heat exchanger is fixed to the base member along the direction of the axis such that the two separation ports communicate with the intermediate passage.

14. The multi-way switching valve device according to claim 6,
wherein in the base member, a second refrigerant-heat medium heat exchanger that performs heat exchange between the refrigerant and the heat medium is disposed between the third inlet side passage and the third outlet side passage.

15. The multi-way switching valve device according to claim 14,
wherein the second refrigerant-heat medium heat exchanger comprises a heat exchange part, an intermediate passage that connects the third inlet side passage and the third outlet side passage, and a second refrigerant passage that forms part of the refrigerant passage, and
an expansion valve is disposed on an upstream side of the second refrigerant passage.

16. The multi-way switching valve device according to claim 15,
wherein a third downstream port of the third inlet side passage and a third upstream port of the third outlet side passage open in a same direction as the cylindrical recess, and
the second refrigerant-heat medium heat exchanger is fixed to the base member along the direction of the axis such that the third downstream port and the third upstream port communicate with the intermediate passage.
